(19) United States
(12) Patent Application Publication
(10) Pub. No.: US 2008/0214712 A1
(43) Pub. Date: Sep. 4, 2008

(54) Adjustble Block Copolymer Having Acid Functional Groups and Adhesive and Thermoplastic Compositon Containing It

(75) Inventors: Nicolas Passade Boupat, Pau (FR); Olivier Guerret, La Tour de Salvagny (FR); Stephanie Magnet, Morlanne (FR); Pierre Gerard, Denguin (FR)

Correspondence Address: MILLEN, WHITE, ZELANO & BRANIGAN, P.C., 2200 CLARENDON BLVD., SUITE 1400, ARLINGTON, VA, 22201, US

(73) Assignee: ARKEMA FRANCE, Puteaux (FR)

(21) Appl. No.: 11/910,799

(22) PCT Filed: Apr. 10, 2006
(86) PCT No.: PCT/FR06/50321

§ 371 Date: Apr. 10, 2008

(30) Foreign Application Priority Data
Apr. 8, 2005 (FR) 05 50916

(51) Int. Cl. C08K 5/09; C08L 53/00

(52) U.S. Cl. 524/272; 525/221; 525/222; 525/218; 524/284

(57) ABSTRACT

The invention relates to a linear ethylenic block copolymer comprising:
at least a first block A having a glass transition temperature above 20° C.;
at least a second block B having a glass transition temperature below 15° C.; and
at least a third block C having a glass transition temperature above 20° C.;
   said first block A and third block C being identical or different and at least one of them comprising at least one monomer unit comprising at least one —CO₂H and/or carboxylate —COO⁻ functional group.

Use of this copolymer in adhesive compositions and thermoplastic compositions.

### TECHNICAL FIELD

The present invention relates to adjustable block copolymers that can be used, in particular, in adhesive compositions such as hot-melt pressure-sensitive adhesive (also known by the abbreviation HMPSA) compositions, and in thermoplastic compositions.

Generally, the adhesive compositions, such as the hot-melt pressure-sensitive compositions, used especially in applications for adhesive strips and labels, must have a compromise of properties between their processing (thermal stability, viscosity level, etc.) and their physical properties (adhesion, cohesion and temperature resistance, etc.). It is generally the same for the thermoplastic compositions.

It is known, in the field of polymers, that the addition of monomers such as methacrylic acid or acrylic acid makes it possible to benefit from an ionomer effect, by neutralization of the acid functional groups with a base, and thus to control the physical properties of the polymer such as the modulus level of the polymer and the temperature resistance.

Until now, polymers of that type have characteristics which make it difficult to incorporate them into adhesive compositions, especially hot-melt pressure-sensitive adhesive compositions, due to their incompatibility with the ingredients commonly used in these compositions, such as the tackifying resins or the oils.

There is therefore a real need for novel polymers whose physical properties (such as the mechanical, thermomechanical, and rheological properties) can be adjusted by simple neutralization of acid functional groups, and which can be easily incorporated into adhesive or thermolastic compositions, without resorting to grades of polymers in order to achieve the desired physical properties for a given use.

### SUMMARY OF THE INVENTION

Thus, the invention relates, according to a first subject, to a linear ethylenic block copolymer comprising:
at least a first block A having a glass transition temperature above 20° C., preferably above 60° C.;
at least a second block B having a glass transition temperature below 15° C., preferably below −30° C.; and
at least a third block C having a glass transition temperature above 20° C., preferably above 60° C.;
   said first block A and third block C being identical or different and at least one of them comprising at least one monomer unit comprising at least one —CO₂H and/or carboxylate —COO⁻ functional group.

Such copolymers are particularly advantageous, in the sense that it can easily be envisaged with these to adjust their physical properties, such as the thermomechanical properties and the rheological properties, by controlling the degree of neutralization of the —CO₂H functional groups.

Thus, starting from a copolymer as defined above, it is possible, by neutralizing all or some of the —CO₂H acid functional groups, to increase the elastic shear modulus and also its temperature resistance by giving it more cohesion. This is because, with the ionization of the copolymers, their glass transition temperature increases and the ionic interactions make it possible to create electrostatic bridges between the polymer chains which influences their mechanical strength.

Starting from the copolymers of the invention, it is also possible, by neutralizing all or some of the —CO₂H acid functional groups, to control the melt viscosity and thus to selectively increase the low shear rate viscosity (for a better creep resistance, for example) while having a much more moderate increase of the viscosity for high shear rates. Therefore, the copolymers of the invention prove particularly advantageous for formulations that comprise a solvent, because the control of the viscosity in these formulations may be crucial therein (especially, for example, for keeping solid particles in a stable suspension).

It is thus possible, using a single grade of copolymer of the invention, to see its properties adapting to a given field of application by having recourse to a judicious neutralization.

Furthermore, due to their intrinsic properties (especially the glass transition temperatures of the blocks), the copolymers may be easily mixed with other ingredients commonly encountered in adhesive and thermoplastic compositions.

The copolymers of the invention are linear ethylenic block copolymers.

The expression “ethylenic copolymer” is understood to mean a copolymer obtained by polymerization of monomers comprising an ethylenic unsaturation.

The expression “block copolymer” is understood to mean a copolymer comprising several distinct, that is to say of different chemical natures, successive blocks (in this case, at least three).

The copolymers of the invention are polymers having a linear structure. In contrast, a polymer having a non-linear structure is, for example, a polymer having a branched, star-shaped, grafted or other structure. In particular, all of the monomers used to prepare a linear polymer are monofunctional, that is to say they only have a single polymerizable functional group. The polymerization initiators may, themselves, be monofunctional or difunctional.

According to the invention, the copolymers respectively comprise a first block A and a third block C, which are identical or different, both respectively having a glass transition temperature above 20° C., at least one of its blocks comprising at least one monomer unit that comprises at least one —CO₂H and/or —COO⁻ functional group. Generally, these monomer units are included in the given block in an amount ranging from 0.5 to 99 mol %, preferably from 3 to 30%, more preferably from 3 to 20 mol %. This means that these blocks are generally derived from several types of different monomers and are thus composed of a copolymer, this copolymer forming the block possibly itself being a random or alternating or gradient copolymer; the distribution of the monomers within each block may therefore be random or controlled depending on the nature and/or the reactivity of the monomers and/or the preparation process used.

It is specified that the expression “monomer unit” is understood, within the meaning of the invention, to denote a unit derived directly from a monomer after its polymerization.

In said A and/or C block, the monomers giving rise, after polymerization, to monomer units comprising at least one —CO₂H functional group, which are able to be used, may be chosen from the monomers corresponding to the formula (I) below:

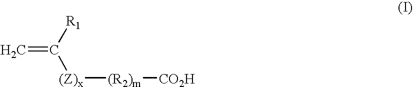

in which:
R₁ is a hydrogen atom or a linear or branched hydrocarbon-based group of CₚH₂ₚ₊₁ type, with p being an integer ranging from 1 to 12;
Z is a divalent group chosen from —COO—, —CONH—, —CONCH₃—, —OCO— or —O—; preferably —COO— and —CONH—;
x is an integer equal to 0 or 1, preferably 1;
R₂ is a saturated or unsaturated, optionally aromatic, linear, branched or cyclic, divalent carbon-based group, comprising from 1 to 30 carbon atoms, which may comprise from 1 to 30 heteroatoms chosen from O, N, S and P; and
m is an integer equal to 0 or 1.

Advantageously, in the formula (I), R₁ is a hydrogen atom or a methyl group, x is equal to 0 and m is equal to 0.

In the group R₂, the heteroatom or heteroatoms, when they are present, may be inserted into the chain of said group R₂, or else said group R₂ may be substituted by one or more groups comprising them such as a hydroxy or amino group (NH₂, NHR′ or NR′R″ with R′ and R″, being identical or different, representing a linear or branched C₁-C₂₂ alkyl group, especially a methyl or ethyl group).

In particular, R₂ may be:
an alkylene group such as a methylene, ethylene, propylene, n-butylene, isobutylene, tert-butylene, n-hexylene, n-octylene, n-dodecylene, n-octadecylene, n-tetradecylene, n-docosanylene group;
an (ortho, meta or para)-C₆H₄— phenylene group, optionally substituted by a C₁-C₁₂ alkyl group optionally comprising from 1 to 8 heteroatoms chosen from O, N, S and P; or else a —C₆H₄—CH₂— benzylene group optionally substituted by a C₁-C₁₂ alkyl group optionally comprising from 1 to 8 heteroatoms chosen from O, N, S and P; and
a group of formula —CH₂—CHOH—, —CH₂—CH₂—CHOH—, —CH₂—CH₂—CH(NH₂)—, —CH₂—CH(NH₂)—, —CH₂—CH₂—CH(NHR′)—, —CH₂—CH(NHR′)—, —CH₂—CH₂—CH(NR′R″)—, —CH₂—CH(NR′R″)—, —CH₂—CH═CH— with R′ and R″, being identical or different, representing a C₁-C₁₈, linear or branched alkyl group, especially methyl or ethyl.

Among the monomers capable of giving rise to more particularly preferred monomer units comprising —CO₂H functional groups, mention may especially be made of acrylic acid, methacrylic acid, crotonic acid, itaconic acid, fumaric acid, maleic acid, diacrylic acid, dimethylfumaric acid, citraconic acid, vinylbenzoic acid, acrylamidoglycolic acid of formula CH₂═CH—CONHCH(OH)COOH, diallyl maleate of formula C₃H₅—CO₂—CH═CH—CO₂—C₃H₅, tert-butyl (meth)acrylate, carboxylic anhydrides bearing a vinyl bond, and also salts thereof; and mixtures thereof. It is understood that for the esters mentioned above, these will be, after polymerization, hydrolysed to result in units bearing —CO₂H functional groups.

In said A and/or C block, the monomers giving rise, after polymerization, to monomer units comprising at least one carboxylate functional group, which are able to be used, may also be chosen from the monomers corresponding to the formula (II) below:

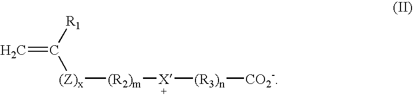

in which:
R₁, Z, x, R₂ and m have the same meanings as in the formula (I) above;
X′⁺ is a divalent group of formula —N⁺R′₆R′₇ with R′₆ and R′₇ representing, independently of one another,

(i) a hydrogen atom;

(ii) a linear, branched or cyclic, optionally aromatic, alkyl group comprising from 1 to 30 carbon atoms, which may comprise from 1 to 8 heteroatoms chosen from O, N, S and P; for example, a methyl, ethyl, propyl, isopropyl, n-butyl, t-butyl or isobutyl group;

(iii) an alkylene oxide group of formula —(R′₈O)_{y}R′₉ with R′₈ representing a C₂-C₄ linear or branched alkyl group, R′₉ representing a hydrogen atom or a C₁-C₃₀, linear or branched, alkyl group and y is an integer ranging from 1 to 250;

(iv) R′₆ and R′₇ may form a saturated or unsaturated, optionally aromatic, ring with the nitrogen atom (NR′₆R′₇ or R′₆NR′₇), comprising in total 5, 6, 7 or 8 atoms, and especially 4, 5, 6 or 7 carbon atoms and/or 2 to 4 heteroatoms chosen from O, S and N; said ring possibly being fused with one or more other saturated or unsaturated, optionally aromatic, rings, each comprising 5, 6, 7 or 8 atoms, and especially 4, 5, 6 or 7 carbon atoms and/or 2 to 4 heteroatoms chosen from O, S and N;
R₃ is a saturated or unsaturated, optionally aromatic, linear, branched or cyclic, divalent carbon-based group comprising from 1 to 30 carbon atoms, which may comprise 1 to 18 heteroatoms chosen from O, N, S and P; and
n is an integer equal to 0 or 1.

In the group R₃, the heteroatom or heteroatoms, when they are present, may be inserted into the chain of said group R₃, or else said group R₃ may be substituted by one or more groups comprising them such as a hydroxy or amino group; in particular R₃ may be:
an alkylene group such as a methylene, ethylene, propylene, n-butylene, isobutylene, tert-butylene, n-hexylene, n-octylene, n-dodecylene, n-octadecylene, n-tetradecylene, n-docosanylene group;
an (ortho, meta or para)-C₆H₄— phenylene group optionally substituted by a C₁-C₁₂ alkyl group optionally comprising from 1 to 5 heteroatoms chosen from O, N, S, F, Si and P; or else a —C₆H₄—CH₂-benzylene group optionally substituted by a C₁-C₁₂ alkyl group optionally comprising from 1 to 5 heteroatoms chosen from O, N, S and P.

Besides the monomer units comprising at least one —CO₂H functional group, the A and/or C blocks may comprise one or more monomer units derived from additional monomers chosen from non-ionic hydrophilic monomers, hydrophobic monomers and mixtures thereof.

These additional monomers may be identical or different from one block to the other.

This or these additional monomers are ethylenic monomers copolymerizable with the ionic hydrophilic monomer or monomers, regardless of their reactivity coefficient.

Preferably, the non-ionic hydrophilic monomers may be present in an amount of 0 to 98% by weight, relative to the weight of the block, especially from 2 to 95% by weight, and even better from 3 to 92% by weight, in at least one block, or even in each block.

Preferably, the hydrophobic monomers may be present in an amount of 0 to 98% by weight, relative to the weight of the block, especially from 2 to 95% by weight, and even better from 3 to 92% by weight, in at least one block, or even in each block.

Among the non-ionic hydrophilic or hydrophobic monomers capable of being copolymerized with the precursor monomers of monomer units bearing CO₂H functional groups mentioned above in order to form the polymers according to the invention, mention may be made, alone or as a mixture, of:

(i) ethylenic hydrocarbons comprising from 2 to 10 carbons, such as ethylene, isoprene, or butadiene; and

(ii) (meth)acrylates of formula:

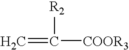

in which R₂ is a hydrogen atom or a methyl (CH₃) group; and R₃ represents:
a linear or branched alkyl group comprising from 1 to 30 carbon atoms, in which one or more heteroatoms chosen from O, N, S and P are found, optionally inserted; said alkyl group possibly, in addition, being optionally substituted by one or more substituents chosen from OH, halogen atoms (Cl, Br, I and F), and the —Si(R′₄R′₅R′₆) and —Si(R′₄R′₅)O groups, in which R′₄, R′₅ and R′₆, being identical or different, represent a hydrogen atom, a C₁ to C₆ alkyl group or a phenyl group;
   in particular, R₃ may be a methyl, ethyl, propyl, n-butyl, isobutyl, tert-butyl, hexyl, ethylhexyl especially 2-ethylhexyl, octyl, lauryl, isooctyl, isodecyl, dodecyl, cyclohexyl, t-butylcyclohexyl or stearyl group; 2-ethylperfluorohexyl or 2-ethylperfluorooctyl group; or a C₁-C₄ hydroxyalkyl group such as a 2-hydroxyethyl, 2-hydroxybutyl and 2-hydropropyl group; or a (C₁-C₄) alkoxy (C₁-C₄) alkyl group such as a methoxyethyl, ethoxyethyl and methoxypropyl group;
a C₃ to C₁₂ cycloalkyl group, such as the isobornyl group;
a C₃ to C₂₀ aryl group, such as the phenyl group;
a C₄ to C₃₀ aralkyl group (C₁ to C₈ alkyl group) such as a 2-phenylethyl, t-butylbenzyl or benzyl group;
a heterocyclic group comprising from 4 to 12 ring members containing one or more heteroatoms chosen from O, N, and S, the ring being aromatic or non-aromatic;
a heterocycloalkyl group (alkyl having 1 to 4 carbon atoms), such as a furfurylmethyl or tetrahydrofurfurylmethyl group;

said cycloalkyl, aryl, aralkyl, heterocyclic or heterocycloalkyl groups possibly being optionally substituted by one or more substituents chosen from hydroxyl groups, halogen atoms, and linear or branched C₁-C₄ alkyl groups in which one or more heteroatoms chosen from O, N, S and P are found, optionally inserted, said alkyl groups possibly, in addition, being optionally substituted by one or more substituents chosen from —OH, halogen atoms (Cl, Br, I and F), and the —Si(R′₄R′₅R′₆) and —Si(R′₄R′₅)O groups, in which R′₄, R′₅ and R′₆, being identical or different, represent a hydrogen atom, a C₁ to C₆ alkyl group, or a phenyl group;
an (OC₂H₄)ₘ—OR″ group, with m=5 to 300 and R″═H or C₁ to C₃₀ alkyl, for example —(OC₂H₄)ₘOH, —(OC₂H₄)—O-methyl or (OC₂H₄)ₘ—O-behenyl; an —(OC₃H₆)ₘ—OR″ group, with m=5 to 300 and R″═H or C₁ to C₃₀ alkyl, for example —(OC₃H₆)ₙ—OH; or else a random or block mixture of (OC₂H₄)ₘ and (OC₃H₆)ₘ groups;

(iii) (meth)acrylamides of formula:

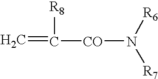

in which R₈ denotes H or methyl;
and R₇ and R₆, being identical or different, represent:
a hydrogen atom; or
a linear or branched alkyl group comprising from 1 to 30 carbon atoms, in which one or more heteroatoms chosen from O, N, S and P are found, optionally inserted; said alkyl group possibly, in addition, being optionally substituted by one or more substituents chosen from —OH, halogen atoms (Cl, Br, I and F), and the —Si(R′₄R′₅R′₆) and —Si(R′₄R′₅)O groups, in which R′₄, R′₅ and R′₆ represent a hydrogen atom, a C₁ to C₆ alkyl group or a phenyl group;

in particular, R₆ and R₇ may be a methyl, ethyl, propyl, n-butyl, isobutyl, tert-butyl, hexyl, ethylhexyl, octyl, lauryl, isooctyl, isodecyl, dodecyl, cyclohexyl, t-butylcyclohexyl or stearyl group; 2-ethylperfluorohexyl or 2-ethylperfluorooctyl group; or a C₁-C₄ hydroxyalkyl group such as a 2-hydroxyethyl, 2-hydroxybutyl and 2-hydropropyl group; or a (C₁-C₄)alkoxy(C₁-C₄)alkyl group such as a methoxyethyl, ethoxyethyl and methoxypropyl group;
a C₃ to C₁₂ cycloalkyl group, such as the isobornyl group;
a C₃ to C₂₀ aryl group, such as the phenyl group;
a C₄ to C₃₀ aralkyl group (C₁ to C₈ alkyl group) such as a 2-phenylethyl, t-butylbenzyl or benzyl group;
a heterocyclic group having 4 to 12 ring members containing one or more heteroatoms chosen from O, N, and S, the ring being aromatic or non-aromatic;
a heterocycloalkyl group (C₁-C₄ alkyl), such as a furfurylmethyl or tetrahydrofurfurylmethyl group;
   said cycloalkyl, aryl, aralkyl, heterocyclic or heterocycloalkyl groups possibly being optionally substituted by one or more substituents chosen from hydroxyl groups, halogen atoms, and linear or branched C₁-C₄ alkyl groups in which one or more heteroatoms chosen from O, N, S and P are found, optionally inserted, said alkyl groups possibly, in addition, being optionally substituted by one or more substituents chosen from —OH, halogen atoms (Cl, Br, I and F), and the —Si(R′₄R′₅R′₆) and —Si(R′₄R′₅)O groups, in which R′₄, R′₅ and R′₆, being identical or different, represent a hydrogen atom, a C₁ to C₆ alkyl group, or a phenyl group;
an —(OC₂H₄)ₘ—OR″ group, with m=5 to 300 and R″═H or C₁ to C₃₀ alkyl, for example —(OC₂H₄)ₘ—OH, —(OC₂H₄)ₘ—O-methyl or —(OC₂H₄)ₘ—O-behenyl; an —(OC₃H₆)ₘ—OR″ group, with m=5 to 300 and R″═H or C₁ to C₃₀ alkyl, for example —(OC₃H₆)ₘ—OH; or else a random or block mixture of (OC₂H₄)ₘ and (OC₃H₆)ₘ groups.

Examples of such additional monomers are (meth)acrylamide, N-ethyl(meth)acrylamide, N-butyl-acrylamide, N-t-butylacrylamide, N-isopropylacrylamide, N,N-dimethyl(meth)acrylamide, N,N-dibutylacrylamide, N-octylacrylamide, N-dodecylacrylamide, N-undecyl-acrylamide, and N-(2-hydroxypropylmethacrylamide).

(iv) vinyl compounds of formula:

CH₂═CH—R₉

in which R₉ is a hydroxyl group; a halogen (Cl or F); an NH₂ group; an —OR₁₀ group where R₁₀ represents a phenyl group or a C₁ to C₁₂ alkyl group (the monomer is a vinyl or allyl ether); an acetamide (NHCOCH₃) group; an OCOR₁₁ group where R₁₁ represents a linear or branched alkyl group having 2 to 12 carbons (the monomer is a vinyl or allyl ester), a C₃-C₁₂ cycloalkyl group, a C₃-C₂₀ aryl group or a C₄-C₃₀ arallyl group; or else R₉ is chosen from:
a linear or branched alkyl group comprising from 1 to 30 carbon atoms, in which one or more heteroatoms chosen from O, N, S and P are found, optionally inserted; said alkyl group possibly, in addition, being optionally substituted by one or more substituents chosen from —OH, halogen atoms (Cl, Br, I and F), and the —Si(R′₄R′₅R′₆) and —Si(R′₄R′₅)O groups, in which R′₄, R′₅ and R′₆, being identical or different, represent a hydrogen atom, a C₁ to C₆ alkyl group or a phenyl group;
a C₃ to C₁₂ cycloalkyl group, such as an isobornyl group or cyclohexane;
a C₃ to C₂₀ aryl group, such as a phenyl group;
a C₄ to C₃₀ arylalkyl or alkylaryl group (C₁ to C₈ alkyl group) such as a 2-phenylethyl or benzyl group;
a heterocyclic group having 4 to 12 ring members containing one or more heteroatoms chosen from O, N, and S, the ring being aromatic or non-aromatic, such as N-vinylpyrrolidone and N-vinylcaprolactam;
a heterocycloalkyl group (alkyl having 1 to 4 carbon atoms), such as a furfurylmethyl or tetrahydrofurfurylmethyl group; said cycloalkyl, aryl, aralkyl, heterocyclic or heterocycloalkyl groups possibly being optionally substituted by one or more substituents chosen from hydroxyl groups, halogen atoms, and linear or branched alkyl groups having 1 to 4 carbon atoms in which one or more heteroatoms chosen from O, N, S and P are found, optionally inserted, said alkyl groups possibly, in addition, being optionally substituted by one or more substituents chosen from —OH, halogen atoms (Cl, Br, I and F), and the —Si(R′₄R′₅R′₆) and —Si(R′₄R′₅)O groups, in which R′₄, R′₅ and R′₆, being identical or different, represent a hydrogen atom, a C₁ to C₆ alkyl group, or a phenyl group.

Examples of such additional monomers are vinylcyclohexane and styrene (hydrophobes); N-vinylpyrrolidone and N-vinylcaprolactam (non-ionic hydrophiles); vinyl acetate, vinyl propionate, vinyl butyrate, vinyl ethylhexanoate, vinyl neononanoate and vinyl neododecanoate (hydrophobes); vinyl methyl ether, vinyl ethyl ether and vinyl isobutyl ether.

(v) the allyl compounds of formula:

CH₂═CH—CH₂—R₉ or CH₂═C(CH₃)—CH₂—R₉

in which R₉ has the same meaning as above.

Mention may especially be made of allyl methyl ether, 3-allyloxy-1,2-propanediol (CH₂═CHCH₂OCH₂CH(OH)CH₂OH) and 2-allyloxyethanol (CH₂═CHCH₂OC₂H₄OH).

(vi) (meth)acrylic, (meth)acrylamide or silicone-containing vinyl monomers, such as methacryloxypropyltris (trimethylsiloxy) silane or acryl-oxypropylpolydimethylsiloxane, or silicone-containing (meth)acrylamides.

Among the most particularly preferred additional (especially non-ionic hydrophilic) monomers, mention may be made, alone or as a mixture, of the following monomers for which the T_{g} is given between brackets by way of indication:
hydroxyalkyl (meth)acrylates and (meth)acrylamides of which the alkyl group comprises 2 to 4 carbon atoms, in particular 2-hydroxyethyl acrylate (T_{g}=15° C.), 2-hydroxyethyl methacrylate (55° C.), 2-hydroxypropyl methacrylate, 4-hydroxybutyl methacrylate, N-(2-hydroxypropyl) (meth)acrylamide;
(C₁-C₄)alkoxy(C₁-C₄)alkyl (meth)acrylates and (meth)acrylamides such as methoxyethyl, 2-ethoxyethyl, methoxypropyl and di(2-ethoxyethyl) (meth)acrylates and (meth)acrylamides; more particularly 2-ethoxyethyl methacrylate;
(meth)acrylamide and N,N-dimethyl-acrylamide;
(meth)acrylates and (meth)acrylamides having an (OC₂H₄)ₘ—OR″ group, with m=5 to 300 and R″═H or C₁ to C₄ alkyl, for example (methoxy- or hydroxy-terminated) polyethylene glycol (meth)acrylates and (meth)acrylamides; and more particularly hydroxy-terminated polyethylene glycol methacrylate (n=8, 10, 12, 45, 90 or 200) and methoxy-terminated polyethylene glycol methacrylate (n=8, 10, 12, 45, 90 or 200)(T_{g}=55° C.);
vinyl lactams such as vinylpyrrolidone and vinylcaprolactam;
vinyl ethers such as vinyl methyl ether (T_{g}=−34° C.) and vinyl ethyl ether;
vinylacetamide, N-vinylpyrrolidone, N-vinylcaprolactam; and
polysaccharide (meth)acrylates such as sucrose acrylate and ethyl glucoside (meth)acrylate.

Mention may also be made, among the more particularly preferred additional (especially hydrophobic) monomers, alone as a mixture, of the following monomers for which the T_{g} is given between brackets by way of indication:
t-butylbenzyl acrylate, t-butylcyclohexyl acrylate, isobornyl acrylate (94° C.), furfuryl acrylate, n-hexyl acrylate (45° C.), t-butyl acrylate (50° C.), cyclohexyl acrylate (19° C.), hydroxyethyl acrylate (15° C.), methyl acrylate (10° C.), ethyl acrylate (−24° C.), isobutyl acrylate (−24° C.), methoxyethyl acrylate (−33° C.), n-butyl acrylate (−54° C.), ethylhexyl acrylate (−50° C.), hexyl acrylate, octyl acrylate, lauryl acrylate, isooctyl acrylate, isodecyl acrylate;
t-butylbenzyl methacrylate, t-butyl-cyclohexyl methacrylate, isobornyl methacrylate (111° C.), methyl methacrylate (100° C.), cyclohexyl methacrylate (83° C.), ethyl methacrylate (65° C.), benzyl methacrylate (54° C.), isobutyl methacrylate (53° C.), butyl methacrylate (20° C.), n-hexyl methacrylate (−5° C.), ethylhexyl methacrylate, octyl methacrylate, lauryl methacrylate, isooctyl methacrylate, isodecyl methacrylate;
styrene (100° C.), vinylcyclohexane, vinylacetate (23° C.), vinyl methyl ether (−34° C.), vinyl neononanoate, vinyl neododecanoate;
N-butylacrylamide, N-isopropylacrylamide, N,N-dimethylacrylamide, N,N-dibutylacrylamide, N-t-butylacrylamide, N-octylacrylamide.

According to one embodiment of the invention, the block B may be composed of monomer units derived from non-ionic hydrophilic and/or hydrophobic monomers as defined above. This block may also comprise —CO₂H functional groups generally derived from the reaction for synthesis of the block copolymer.

According to one preferred embodiment of the invention, the copolymers of the invention are triblock copolymers, generally of A-B-C type, the blocks A, B and C corresponding to the same definition as that given above.

Advantageously, the block B is present in an amount ranging from 5 to 95% by weight of the copolymer, preferably in an amount greater than 50% by weight of the copolymer.

According to one embodiment, the block A and/or C comprises:
monomer units derived from non-ionic monomers chosen from:
   vinyl compounds of formula CH₂═CH—R₉, R₉ being as defined above, such as styrene;
   methacrylate compounds of formula:

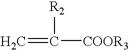

with R₂ and R₃ being as defined above, such as methyl methacrylate; and
monomer units bearing at least one —CO₂H functional group derived from monomers chosen from acrylic acid or methacrylic acid.

The monomer units derived from non-ionic monomers are present, for example, in an amount ranging from 1 to 99.5% relative to the total weight of the block.

The monomer units bearing at least one —CO₂H functional group are present, for example, in an amount ranging from 0.5 to 99% relative to the total weight of the block.

According to one embodiment, the block B comprises monomer units derived from monomers chosen from (meth)acrylates of formula:

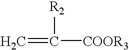

with R₂ and R₃ being as defined above.

Monomers included in this definition and possibly advantageously being incorporated in the composition of the block B comprise n-hexyl methacrylate (T_{g}=−5° C.), ethyl acrylate (T_{g}=−24° C.) isobutyl acrylate (T_{g}=−24° C.), n-butyl acrylate (T_{g}=−54° C.), ethylhexyl acrylate (T_{g}=−50° C.).

In particular, the block B may be composed of monomer units derived from n-butyl acrylate.

Triblock copolymers conforming to the invention may be chosen from poly(styrene-co-methacrylic acid)-b-poly(n-butyl acrylate)-b-poly(styrene-co-methacrylic acid), poly(methyl methacrylate-co-methacrylic acid)-b-poly(n-butyl acrylate)-b-poly(methyl methacrylate-co-methacrylic acid).

More specifically, one particular poly(styrene-co-methacrylic acid)-b-poly(n-butyl acrylate)-b-poly(styrene-co-methacrylic acid) copolymer is that for which:
the poly(n-butyl acrylate) block represents 70% by weight of the total copolymer;
the poly(styrene-co-methacrylic acid) blocks each comprise monomer units derived from methacrylic acid in an amount of 2% by weight of the total copolymer and monomer units derived from styrene in an amount of 12.5% by weight of the total copolymer; and
a weight-average molecular weight of 372 000 g/mol.

One poly(methyl methacrylate-co-methacrylic acid)-b-poly(n-butyl acrylate)-b-poly(methyl meth-acrylate-co-methacrylic acid) copolymer is that for which:
the poly(n-butyl acrylate) block represents 35% by weight of the total copolymer;
the poly(methyl methacrylate-co-methacrylic acid) blocks each comprise monomer units derived from methacrylic acid in an amount of 3.25% by weight of the total copolymer and monomer units derived from methyl methacrylate in an amount of 29.25% by weight of the total copolymer; and

a weight-average molecular weight of 150 000 g/mol.

Another poly(methyl methacrylate-co-meth-acrylic acid)-b-poly(n-butyl acrylate)-b-poly(methyl methacrylate-co-methacrylic acid) copolymer is that for which:
the poly(n-butyl acrylate) block represents 65% by weight of the total copolymer;
the poly(methyl methacrylate-co-methacrylic acid) blocks each comprise monomer units derived from methacrylic acid in an amount of 1.6% by weight of the total copolymer and monomer units derived from methyl methacrylate in an amount of 15.9% by weight of the total copolymer; and
a weight-average molecular weight of 95 000 g/mol.

The weight-average molecular weight M_{w} of the block copolymer according to the invention is preferably greater than 10 000 g/mol, preferably greater than 50 000 g/mol and less than 500 000 g/mol, preferably less than 300 000 g/mol.

Advantageously, the weight-average molecular weight M_{w} of each block or sequence is between 5000 g/mol and 200 000 g/mol, preferably between 10 000 g/mol and 100 000 g/mol.

In order to be able to adjust the physical properties of the copolymers of the invention, it is possible to play on the degree of neutralization of the acid functional groups of the copolymers of the invention.

In order to do that, the —CO₂H acid functional groups may be neutralized, advantageously, by mineral bases chosen from:
alkali metal hydroxides, such as LiOH, NaOH or KOH;
alkaline-earth metal hydroxides, such as Ca(OH)₂;
metal hydroxides, such as zinc hydroxide, zinc acetate, iron hydroxide, or copper hydroxide; and
metalloid hydroxides such as aluminium hydroxide.

The acid functional groups may also be neutralized by organic bases such as amines, in particular amines having a boiling point above 200° C. at 1 atm. As amines that can be envisaged, mention may be made of primary, secondary or tertiary alkyl amines, especially triethylamine or butylamine. This primary, secondary or tertiary alkyl amine may comprise one or more nitrogen and/or oxygen atoms and may therefore comprise, for example, one or more alcohol functional groups; mention may especially be made of 2-amino-2-methylpropanol, triethanolamine and 2-dimethyl-aminopropanol. Mention may also be made of lysine, 3-(dimethylamino)propylamine and urea.

This degree of neutralization will be able to be chosen judiciously as a function of the desired properties.

The degree of neutralization, corresponding to the ratio between the number of moles of acid functional groups present in one kilogram of the copolymer and the number of moles of basic functional groups mixed per kilogram of polymer is, advantageously, greater than 0.1, preferably greater than 0.5.

Said polymers may be prepared according to the methods known to a person skilled in the art. Among these methods, mention may be made of anionic polymerization, controlled radical polymerization, controlled for example by xanthanes, dithiocarbamates or dithioesters; polymerization using nitroxide type precursors; atom transfer radical polymerization (ATRP); and group transfer polymerization.

For example, the block copolymers according to the invention may be obtained by living or pseudo-living, also called controlled, radical polymerization, described in particular in “New Method of Polymer Synthesis”, Blackie Academic & Professional, London, 1995, volume 2, page 1.

Controlled radical polymerization denotes polymerizations for which the secondary reactions that usually lead to the disappearance of the propagating species (termination or transfer reaction) are rendered highly unlikely relative to the propagation reaction due to a free radical control agent. The imperfection of this polymerization method lies in the fact that when the free-radical concentrations become large with respect to the monomer concentration, the secondary reactions become determining again and tend to widen the weight distribution.

As a matter of interest, it is recalled that the living or pseudo-living polymerization is a polymerization for which the growth of the polymer chains only stops with the disappearance of the monomer. The number-average molecular weight (Mₙ) increases with the conversion. Such polymerizations result in copolymers of which the dispersity by mass is low, that is to say in polymers having a mass polydispersity index (PI) generally below 2.

Anionic polymerization is a typical example of living polymerization.

Pseudo-living polymerization is, itself, associated with controlled radical polymerization. Among the main types of controlled radical polymerization, mention may be made of:
controlled radical polymerization using nitroxides. Reference may especially be made to Patent Applications WO 96/24620 and WO 00/71501 which describe the tools of this polymerization and their implementation, and also to the articles published by Fischer (Chemical Reviews, 2001, 101, 3581), by Tordo and Gnanou (J. Am. Chem. Soc. 2000, 122, 5929) and Hawker (J. Am. Chem. Soc. 1999, 121, 3904);
atom transfer radical polymerization, especially described in Application WO 96/30421 and which proceeds by the reversible insertion into an organometallic complex in a carbon-halogen type bond;
the controlled radical polymerization using sulphur-containing derivatives of xanthate, dithioester, trithiocarbonate or carbamate type, as described in Applications FR 2821620, WO 98/01478, WO 99/35177, WO 98/58974, WO 99/31144, WO 97/01478 and in the publication by Rizzardo et al. (Macromolecules, 1998, 31, 5559).

Due to these polymerization methods, the polymer chains of the copolymers grow at the same time and therefore incorporate at each moment the same ratio of comonomers. All the chains have therefore the same structures or similar structures, hence a low dispersity of the composition. These chains also have a low mass polydispersity index.

Thus, the polymerization may be carried out according to the atom transfer radical polymerization or “ATRPI” technique or by reaction with a nitroxide, or else according to the reversible addition-fragmentation chain transfer (“RAFT”) technique or finally by the reverse ATRP technique.

The atom transfer radical polymerization technique consists in blocking the radical species growing in the form of a C-halide type bond (in the presence of a metal/ligand complex). This type of polymerization is expressed by a control of the mass of the polymers formed and by a low mass dispersity index. Generally, the atom transfer radical polymerization is carried out by polymerizing one or more polymerizable monomers via a radical route, in the presence of:
an initiator having at least one transferable halogen atom;
a halogen compound comprising a transition metal capable of participating in a reduction step with the initiator and a “dormant” polymer chain, this will be known as a “chain transfer agent”; and
a ligand which may be chosen from compounds comprising a nitrogen (N), oxygen (O), phosphorus (P) or sulphur (S) atom, capable of coordinating via a σ bond to said compound comprising a transition metal, the formation of direct bonds between said compound comprising a transition metal and the polymer in formation being avoided.

The halogen atom is preferably a chlorine or bromine atom.

This process is, in particular, described in Application WO 97/18247 and in the article by Matyjasezwski et al. published in JACS, 117, page 5614 (1995).

The radical polymerization technique by reaction with a nitroxide consists in blocking the growing radical species in the form of a C—O—NRaRb type bond where Ra and Rb may be, independently of one another, an alkyl radical having from 2 to 30 carbon atoms or both forming, with the nitrogen atom, a ring having from 4 to 20 carbon atoms, such as for example a 2,2,6,6-tetramethylpiperidinyl ring. This polymerization technique is especially described in the articles “Living free radical polymerization: a unique technique for preparation of controlled macromolecular architectures” C J Hawker; Chem. Res. 1997, 30, 373-82, and “Macromolecular engineering via living free radical polymerizations” published in macromol. Chem. Phys. 1998, Vol. 199, pages 923-935, or else in Application WO-A-99/03894.

The RAFT (Reversible Addition-Fragmentation Transfer) polymerization technique consists in blocking the growing radical species in the form of a C—S type bond. For this, dithio compounds are used, like dithioesters (—C(S)S—), such as dithiobenzoates, dithiocarbamates (—NC(S)S—) or dithiocarbonates (—OC(S)S—) (xanthates). These compounds make it possible to control the growth of the chain of a wide range of monomers. However, the dithioesters inhibit the polymerization of vinyl esters, whereas the dithiocarbamates are very slightly active with respect to methacrylates, which limits, to a certain extent, the application of these compounds. This technique is especially described in Application WO-A-98/58974 by Rhodia and in the article “A more versatile route to block copolymers and other polymers of complex architecture by living radical polymerization: the RAFT process”, published in Macromolecules, 1999, volume 32, pages 2071-2074. The aforementioned Application WO-A-98/58974 and the Application WO-A-99/31144 by CSIRO related to the use of dithiocarbamates as “RAFT” reagents.

By varying the ratio of the monomer concentration to the concentration of chain transfer agent, the molecular weight of the polymer may be modified.

The polymerization generally takes place in several steps according to the following general scheme:
a) in a first step, the polymerization of the first monomer or mixture of monomers is carried out in order to form a macroinitiator or precursor;
b) the polymers may be purified by precipitation then dried under vacuum; and
c) in a second step, the polymerization of the second block composed of a monomer or a mixture of monomers is carried out at the end of the macroinitiator.

Steps b and c are repeated as many times as necessary according to the number of blocks, which is the case for the production of ABC type triblock or (ABC)ₙ multiblock polymers with A, B and C being as defined previously.

Usually, to produce symmetrical triblock polymers of ABA or BAB type, a difunctional initiator is generally used.

The chain transfer agents and solvents may be identical or different in step a) and step b).

The block or sequenced polymers according to the invention may also be obtained using the conventional radical polymerization technique by casting the monomers sequentially. In this case, only the control of the nature of the blocks is possible (no control of the weights).

This involves polymerizing, in a first step, a monomer M1 in a polymerization reactor; monitoring, for example via kinetics, its consumption over time then when M1 is around 95% consumed, introducing a new monomer M2 into the polymerization reactor. A polymer of type M1-M2 block structure is thus easily obtained.

As mentioned above, the copolymers can see their physical properties (such as elastic shear modulus or temperature resistance) adjusted. It is therefore quite naturally that the polymers of the invention find an application in the field of adhesives and the field of thermoplastic compositions.

Thus, the invention also relates to a composition comprising at least 1% by weight, relative to the total weight of the composition, of a copolymer as defined previously.

In particular, the composition may be an adhesive composition. In this case, the copolymer is advantageously present in an amount of at least 5% by weight relative to the total weight of the composition.

The adhesive composition may comprise additives such as tackifying resins, plasticizers, such as oils, in which case it will form a hot-melt pressure-sensitive adhesive (known by the abbreviation HMPSA) composition.

Without wanting to be limited to the theory, the glass transition temperature of an HMPSA composition will be controlled by the glass transition temperatures of the soft phase of the copolymer (that is to say, in this case, the phase having a T_{g} below 15° C.), of the resin and of the oil (fulfilling the role of plasticizer) and by their respective weight fractions in the soft phase according to a rule of the type:

$$\frac{t}{{T}_{g , soft}} = \frac{{w}_{res , soft}}{{T}_{g , res}} + \frac{{w}_{soft}}{{T}_{g , BAu}} + \frac{{w}_{oil , soft}}{{T}_{g , oil}}$$

where

w_{soft} is the weight fraction of the block of the copolymer having a T_{g} below 15° C.;

w_{res, soft} is the weight fraction of resin incorporated into the low-T_{g} (below 20° C.) phase;

wₒᵢₗ, soft is the weight fraction of oil incorporated into the low-T_{g} (below 20° C.) phase;

T_{g, res} is the glass transition temperature of the resin measured at the stress frequency of 1 Hz;

T_{g, oil} is the glass transition temperature of the oil measured at the stress frequency of 1 Hz on the pure copolymer; and

T_{g, soft} is the glass transition temperature of the low-T_{g} (that is to say below 15° C. in this case) block of the type measured at the stress frequency of 1 Hz on the pure copolymer.

So that the composition can have adhesive properties at ambient temperature, it will be particularly important that the glass transition temperature be below the ambient temperature.

In the present invention, it has been discovered that neutralization did not modify the glass transition temperature of the copolymer, therefore of a final adhesive composition. This therefore makes it possible to be able to control the elastic modulus of the product or of a formulation without increasing its glass transition temperature, as is usually the case.

By using neutralization of the copolymer, it will thus be possible to be able to change the modulus of the final adhesive composition and therefore its fields of application while having used, for the most part, the same raw materials.

Similarly, in adhesive compositions, one very important property relates to the behaviour of the adhesive at temperature. This behaviour is usually characterized by the SAFT (or PAFT) test. The SAFT (or PAFT) test measures the ability of a hot-melt adhesive to resist a static load of 500 g (or 100 g) in shear (or in peel) under the effect of a regular temperature increase of 0.4° C./min. It is therefore clear to a person skilled in the art that the SAFT of a given composition will be connected to its ability to maintain its modulus level, at low deformation rates such as are encountered in creep over the widest temperature range.

Generally, the oils to be used as plasticizers in HMPSA compositions are trimellitate type oils, such as trioctyl trimellitate or else predominantly naphthenic oils such as CATENEX N956 from Shell. It is inadvisable to use oils of the paraffin type (typically PRIMOL 352 oil from Exxon Mobil) or of liquid polybutene type (typically NAPVIS 10) as, under certain conditions, they are incompatible with the copolymer and exude from the mixture.

According to the invention, the tackifying resins are generally resins based on rosins such as FORAL AX, rosin ester such as FORAL F85, resins known under the pure monomer name such as KRYSTALLEX F85, polyterpenes such as DERCOLYTE A 115 from DRT, hydroxylated polyesters (typically REAGEM 5110 from DRT), terpene-styrenes (typically DERCOLYTE TS 105 from DRT), terpene-pentaerythritols (typically DERTOLINE P2L), and resins based on terpene-phenol (typically DERTOPHENE T105 from DRT).

The composition of the invention may be used as an adhesive for forming, for example, adhesive strips, labels and tapes, in various fields, such as the fields of hygiene, wood, binding, or packaging.

The invention also relates to the use of a copolymer as defined above as a hot-melt adhesive.

The compositions of the invention may also be thermoplastic compositions. As additives, such compositions may comprise, moreover, one or more thermoplastic polymers, such as polymethyl methacrylate, polystyrene and polyvinyl chloride.

By using the copolymers of the present invention, it will be possible to be able to control the modulus level of a given copolymer by the level of neutralization of the reactive monomers.

This control of the modulus level may be carried out without increasing the glass transition temperature of the elastomeric domains, which will enable the impact-reinforcement contribution provided by these domains to be remained. On the other hand, the use of the present invention will make it possible to advantageously increase the temperature stability of the thermoplastic phase of the copolymer. This will result in an improvement of the properties when the product is used in applications which expose it to high temperatures, such as in the lighting field.

In addition, it will also be possible to give the polymer improved creep resistance properties by the increase of its low shear-gradient viscosity. This is a great advantage for parts subjected to long-term stresses such as pipes or tubes.

Thus, parts will be able to be injection-moulded, moulded, laminated, extruded or thermoformed which will have excellent mechanical and thermal strength during their application (glazing, Fresnel lens for a headlight, composition intended for uses in proximity to a heat source such as a motor vehicle engine).

Whether it is for the adhesive compositions or the thermoplastic compositions, they generally comprise a mineral or organic base as defined above, so as to neutralize all or some of the CO₂H acid functional groups, with a view to adjusting the physical properties of said composition.

The compositions comprising copolymers according to the invention that are completely or partly neutralized may be produced via a liquid route, in which case the process comprises a step of bringing the copolymer into contact, in a liquid medium, with a mineral or organic base, or by a melt route, in which case the process comprises a step of bringing the copolymer into contact, via a melt route, with a mineral or organic base.

The invention will now be descried with reference to the following examples given by way of illustration and non-limitingly.

### BRIEF DESCRIPTION OF THE DRAWINGS

FIGS. 1 to 15 illustrate, in the form of graphs, the effect of the neutralization of copolymers of the invention on the physical properties of these.

### DETAILED SUMMARY OF PARTICULAR EMBODIMENTS

In order to explain the examples below, the following methods and tests used in the context of these examples will be defined.

### 1) Mixing in a Brabander

The various melt-blended mixtures which are given in the examples below were produced in a Rheocord microcompounder, the mixing chamber of which was 66 cm³. The mixing conditions, temperature and speed, were adapted to the mixture and will be specified in the examples. During the mixing, it is possible to record the torque supplied by the rotors during the mixing, which is very useful data as it is connected to the viscosity of the product under the experimental conditions.

### 2) DMTA (or DMA) Measurement

DMTA (or DMA) (meaning dynamic thermal analysis) is a method of analysis which measures the viscoelastic properties (G′, G″, tand, eta*, etc.) of a product as a function of the temperature at the given stress frequency, of 1 Hz in these examples.

It is specified that the quantities G′, G″, tand and eta* correspond respectively to the elastic modulus, to the loss modulus (in Pa), to the G″/G′ ratio and to the viscosity (in Pa/s).

These measurements were carried out on an ARES type rheometer from Rheometrics Scientific.

### 3) Capillary Rheology Measurement

The capillary rheology measurements were carried out on a double barrelled ROSAND RH7 rheometer by applying the Bagley and Rabinowitch corrections known to a person skilled in the art. These measurements carried out on a molten product make it possible to characterize the behaviour of a product at a given temperature at high shear gradients, such as those usually encountered during the processing of plastic materials or of adhesive formulations.

### 4) Dynamic Viscoelasticity Measurement

The dynamic viscoelasticity measurements were carried out on an ARES viscoelasticity meter from Rheometrics Scientific with 25 mm plate/plate geometry. The viscoelastic properties of a product were determined as a function of the dynamic stress frequency at a given temperature.

### 5) Tensile Measurement

The tensile measurements were carried out at ambient temperature at a pull rate of 50 mm/min on an Adamel Lhomargy DY 30 machine according to the ISO 527-2 standard.

The test specimens were cut out using a Charly Robot guided milling machine on the model of test specimens of type 5A. A minimum of 5 tests was carried out for each product.

From the geometry of the sample, the Young's modulus E of the material was determined by taking the slope at the origin of the stress=f(deformation) curve over an average of tests per product.

### Example 1

### Preparation of the Poly(Styrene-co-Methacrylic Acid)-b-poly(n-butyl acrylate)-b-poly(styrene-co-methacrylic acid) copolymer, denoted by PRC 302

Introduced into a 500 ml reactor equipped with a variable-speed stirrer motor, inlets for the introduction of reactants, branch pipes for the introduction of inert gases, such as nitrogen, which make it possible to flush out the oxygen, and measurement probes (e.g. temperature probes), a jacket that makes it possible to heat/cool the contents of the reactor due to the circulation within it of a heat-exchange fluid, were: 136 g of n-butyl acrylate, 3.47 g of a 1,6-di[2-(N-tert-butyl-N-(1-diethylphosphono-2,2-dimethylpropyl)-N-oxyl)propionate]hexylene alkoxyamine solution denoted by “DIAMS” of the following formula:

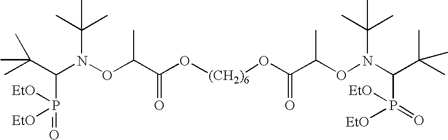

at 20% by weight in ethylbenzene and 0.375 g of an N-tert-1-diethyl phosphono-2,2-dimethyl propyl nitroxide solution denoted by “SG1” of formula:

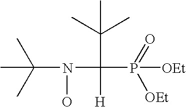

at 10% by weight in ethylbenzene. The reaction medium was then brought to 114° C., and this temperature was held for 6 hours until a degree of conversion of n-butyl acrylate (BuA) of around 70% was attained. The residual monomer was then removed at 75° C. under 200-300 mbar. The molecular weights of the poly(n-butyl acrylate) in polystyrene equivalents, determined by SEC, were 90 140 g/mol for the weight at the distribution peak (Mₚ), 57 730 for the number-average molecular weight (Mₙ), 89 650 for the weight-average molecular weight (M_{w}) and a polydispersity index of 1.6.

In a second synthesis step, 133 g of toluene, 35 g of styrene (S) and 6 g of methacrylic acid (MAA) were introduced into the reactor containing the previously synthesized poly(n-butyl acrylate). After degassing with nitrogen, the temperature was adjusted to 120° C. and held for 4 hours. After devolatilization of the residual monomers and solvent, followed by a granulating step, the poly(styrene-co-methacrylic acid)-b-poly(n-butyl acrylate)-b-poly (styrene-co-methacrylic acid) copolymer was recovered in the form of granules. The chemical composition of the copolymer obtained, expressed as a weight percentage, was the following: PBuA/P(S/MAA)=70/30 (86,14). The molecular weights of the copolymer in polymethyl methacrylate equivalents, determined by SEC, were 372 280 g/mol for the weight-average molecular weight (M_{w}).

### Characteristics of PRC 302 P(S/MAA)-PBuA-P(S/MAA):

M_{w}=372 000 g/mol, PI 6.7, Composition: (12.5% S-2% MAA)-71% BuA-(12.5% S-2% MAA).

### Example 2

### Preparation of the Poly(Methyl Methacrylate-co-methacrylic acid)-b-poly(n-butyl acrylate)-b-poly (methyl methacrylate-co-methacrylic acid) copolymer, denoted by DC59

Introduced into a 20 l reactor equipped with a variable-speed stirrer motor, inlets for the introduction of reactants, branch pipes for the introduction of inert gases, such as nitrogen, which make it possible to flush out the oxygen, and measurement probes (e.g. temperature probes), a jacket that makes it possible to heat/cool the contents of the reactor due to the circulation within it of a heat-exchange fluid, were: 11 kg of n-butyl acrylate, 154 g of 1,6-di[2-(N-tert-butyl-N-(1-diethylphosphono-2,2-dimethylpropyl)-N-oxyl)propionate]hexylene alkoxy-amine denoted by “DIAMS” (ARKEMA) and 10.8 g of N-tert-1-diethyl phosphono-2,2-dimethyl propyl nitroxide denoted by “SG1” (ARKEMA). The reaction medium was then brought to 117° C., and this temperature was held for 6 hours until a degree of conversion of n-butyl acrylate of around 60% was attained. The residual monomer was then removed at 75° C. under 200-300 mbar. The poly(n-butyl acrylate) was then diluted in 5.9 kg of toluene, and the toluene solution was drained from the reactor. The molecular weights of the poly(n-butyl acrylate) in polystyrene equivalents, determined by SEC, were 52 726 g/mol for the weight at the distribution peak (Mₚ), 46 100 for the number-average molecular weight (Mₙ), 109 000 for the weight-average molecular weight (M_{w}) and a polydispersity index of 2.4.

In a second synthesis step, 5 kg of the previously prepared toluene solution of poly(n-butyl acrylate), 4 kg of toluene, 8.01 kg of methyl methacrylate and 0.9 kg of methacrylic acid were introduced into the reactor. After degassing with nitrogen, the temperature was adjusted to 100° C. for 1 h 30 min, then to 120° C. for 1 h 30 min. After devolatilization of the residual monomers and solvent, followed by a granulating step, the P(MMA/MAA)-PBuA-P(MMA/MAA) copolymer was recovered in the form of granules. The chemical composition of the copolymer obtained, expressed as a weight percentage, was the following: PBuA/P(MMA/MAA)=35/65 (90/10). The molecular weights of the copolymer in polymethyl methacrylate equivalents, determined by SEC, were 123 100 g/mol for the weight at the distribution peak (Mₚ), 75 620 for the number-average molecular weight (Mₙ), 153 300 for the weight-average molecular weight (M_{w}) and a polydispersity index of 2.0.

### Characteristics of DC59 P(MMA/MAA)-PBuA-P(MMA/MAA):

M_{w}=150 000 g/mol, Composition: (29.25% MMA-3.25% MAA)-35% BuA-(29.25% MMA-3.25% MAA)

### Example 3

### Preparation of the Poly(Methyl Methacrylate-co-Meth acrylic acid)-b-poly(n-butyl acrylate)-b-poly(methyl methacrylate-co-methacrylic acid) copolymer, denoted by PIL 0407

Introduced into a 20 l reactor equipped with a variable-speed stirrer motor, inlets for the introduction of reactants, branch pipes for the introduction of inert gases, such as nitrogen, which make it possible to flush out the oxygen, and measurement probes (e.g. temperature probes), a jacket that makes it possible to heat/cool the contents of the reactor due to the circulation within it of a heat-exchange fluid, were: 11 kg of n-butyl acrylate, 154 g of 1,6-di[2-(N-tert-butyl-N-(1-diethylphosphono-2,2-dimethylpropyl)-N-oxyl)propionate]hexylene alkoxy-amine denoted by “DIAMS” (ARKEMA) and 10.8 g of N-tert-1-diethyl phosphono-2,2-dimethyl propyl nitroxide denoted by “SG1” (ARKEMA). The reaction medium was then brought to 117° C., and this temperature was held for 6 hours until a degree of conversion of n-butyl acrylate of around 60% was attained. The residual monomer was then removed at 75° C. under 200-300 mbar. The poly(n-butyl acrylate) was then diluted in 5.9 kg of toluene, and the toluene solution was drained from the reactor. The molecular weights of the poly(n-butyl acrylate) in polystyrene equivalents, determined by SEC, were 52 726 g/mol for the weight at the distribution peak (Mₚ), 46 100 for the number-average molecular weight (Mₙ), 109 000 for the weight-average molecular weight (M_{w}) and a polydispersity index of 2.4.

In a second synthesis step, 5 kg of the previously prepared toluene solution of poly(n-butyl acrylate), 4.78 kg of toluene, 1.87 kg of methyl methacrylate (MMA) and 0.21 kg of methacrylic acid (MAA) were introduced into the reactor. After degassing with nitrogen, the temperature was adjusted to 105° C. for 1 h 30 min, then to 120° C. for 1 h 30 min. After devolatilization of the residual monomers and solvent, followed by a granulating step, the P(MMA/MAA)-PBuA-P(MMA/MAA) copolymer was recovered in the form of granules. The chemical composition of the copolymer obtained, expressed as a weight percentage, was the following: PBuA/P(MMA/MAA)=73/27 (90/10). The molecular weights of the copolymer in polymethyl methacrylate equivalents, determined by SEC, were 77 030 g/mol for the weight at the distribution peak (Mₚ), 50 940 for the number-average molecular weight (Mₙ), 95 240 for the weight-average molecular weight (M_{w}) and a poldispersity index of 1.9.

### Characteristics of PIL 0407

PIL 0407-P(MMA/MAA)-PBuA-P(MMA/MAA): M_{w}=95 000 g/mol, PI=1.9, Composition: (15.9% MMA/1.6% MAA)-65% PBUA-(15.9% MMA/1.6% MAA)

### Example 4

This example illustrates the effect of the neutralization, by a solvent route, of the PRC 302 copolymer on the level of the elastic shear modulus G′.

The PRC 302 copolymer was dissolved in a solvent, for example THF, by adding a diluent solution of KOH in water so as to introduce one equivalent of OH⁻ per equivalent of acid functional group of the PRC 302 (for example, to neutralize to equivalence of 30 g of a copolymer containing 5% of MAA, it is necessary to introduce 0.97 g of KOH dissolved in around 5 g of water). The mixture was then stirred at ambient temperature for several hours, then the solvents were evaporated firstly at 60° C. then, when the main part of the solvent was removed, by putting the product in a vacuum oven at 120° C. for 1 hour.

A sample of PRC 302 was prepared in an equivalent manner without introduction of base to neutralize the product.

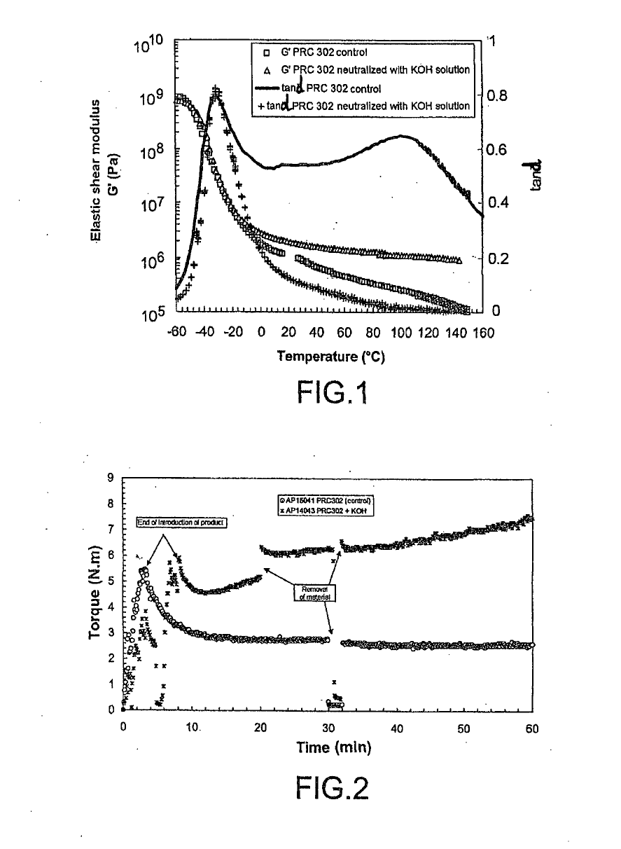

The two products were analysed by DMA as illustrated in FIG. 1, which shows the change of the elastic shear modulus G′ (Pa) as a function of the temperature (° C.) and also the change in tand as a function of the temperature.

Table 1 below shows the increase of the elastic shear modulus for the neutralized PRC 302 in comparison with the non-neutralized product.

| | | | T_{g} of poly(BuA) |
|---|---|---|---|
| | G′ (25° C.)(Pa) | G′ (60° C.)(Pa) | block |
| PRC 302 | 1.0 × 10⁶ | 2.6 × 10⁵ | −30° C. |
| PRC 302 | 1.8 × 10⁶ | 1.4 × 10⁶ | −30° C. |
| neutralized in | | | |
| solution | | | |
| Increase factor | 1.8 | 5.3 | |

In this example, it is clear to a person skilled in the art that the level of the modulus G′ of the copolymer at ambient temperature has been improved without modifying the glass transition temperature of the low-T_{g} phase. This means that the mechanical strength illustrated by G′ increases without affecting the elastomeric properties of the material. The curves showing the change of G′, G″ and tand as a function of the temperature indicate that it has been possible to considerably increase the temperature resistance of the product at low deformation rates such as those used for the measurement between the control without neutralization and the product which has undergone neutralization with potassium hydroxide in solution.

### Example 5

This example illustrates the effect of the neutralization, by a solvent route, of the PRC 302 copolymer on the viscosity, the elastic shear modulus G′, the Young's modulus, and the thickening at low shear gradients.

The PRC 302 copolymer was melt-blended in a Brabender mixer at the temperature of 180° C. for 1 hour with or without the introduction of KOH, the pellets of which were milled in the form of powder.

FIG. 2 compares the change of the torque of the mixture for the product with KOH and for the control. Table 2 collates the various information on the mixtures used.

| | | | | | Weight | Weight | Torque | Final | |
|---|---|---|---|---|---|---|---|---|---|
| | | Tₘᵢₓₜᵤᵣₑ | V | T | (g) of | (g) of | (30 min) | torque | T |
| Ref. | Product | (° C.) | (rpm/min) | (min) | PRC 302 | base | (N · m) | (N · m) | max |
| AP15041 | PRC 302 | 180 | 50 | 10 | 60 | — | 2.75 | 2.6 | 184 |
| AP14043 | PRC 302 + KOH | 180 | 50 | 10 | 60 | 1.6 | 6.3 | 4.5 | 183 |

V corresponds to the rotational speed of the rotors in the mixer and Tₘₐₓ corresponds to the self-heating temperature caused by the shear phenomenon.

It is clear to a person skilled in the art that the difference in the torque level recorded between the product with and without KOH clearly derives from a viscosity increase after neutralizing with the base and not only after adding an additional charge.

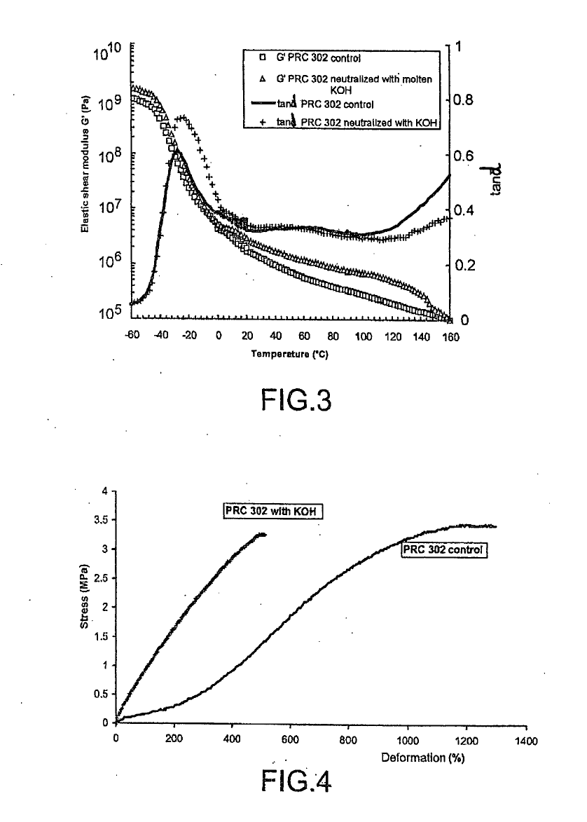

FIG. 3 presents the DMA and the comparison of the elastic shear moduli for these two products.

Table 3 collates the following results:

| | G′ (25° C.) | G′ (60° C.) | T_{g} of poly(BuA) |
|---|---|---|---|
| | (Pa) | (Pa) | block |
| PRC 302 | 1.5 × 10⁶ | 5.7 × 10⁵ | −26° C. |
| PRC 302 | 2.4 × 10⁶ | 1.2 × 10⁶ | −24° C. |
| neutralized with | | | |
| KOH in the melt | | | |
| state | | | |
| Increase factor | 1.6 | 2.0 | |

It is possible to note, as for the neutralization in solution, that the neutralization via a molten route makes it possible to improve the level of the elastic shear modulus of the product at ambient temperature without modifying the glass transition temperature of the low-T_{g} phase. It is also clear that it has been possible to considerably increase the temperature resistance of the product at low deformation rates such as those used for the measurement.

It is also possible to demonstrate this neutralizing effect by carrying out tensile measurements on the samples at ambient temperature. FIG. 4 shows the tensile curve at 50 mm/min for the neutralized product in comparison with the non-neutralized product.

Table 4 gives the following results.

| | PRC 302 | PRC 302 + KOH |
|---|---|---|
| Max stress | 3.6 ± 0.1 | 3.3 ± 0.1 |
| (MPa) | | |
| % deformation | 1200 ± 111 | 506 ± 25 |
| Young's modulus (Pa) | 143 ± 6 | 823 ± 37 |
| Increase of the modulus | | 5.8 |

From this table it emerges that the increase of the Young's modulus is of the order of a factor of 6 after neutralization.

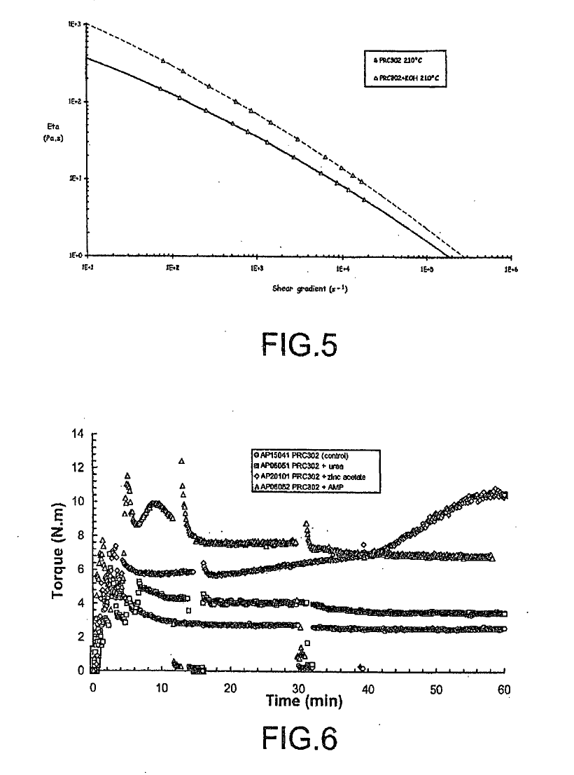

FIG. 5 shows the capillary rheology at 210° C. of the two products. The neutralization provides a significant thickening of the product at low shear gradients, but at the high shear gradients such as those encountered in processing the difference is smaller.

### Example 6

It is possible to use various bases to achieve this neutralization which enables the properties of the products of the invention to be adjusted.

Thus, it could be advantageous to use, for example, 2-amino-2-methylpropanol which is a liquid having a high boiling point (160° C.) instead of KOH which is a solid having a high melting point. As a comparison, the use of zinc acetate has also been illustrated.

Table 5 collates the information on the various mixtures achieved.

| | | | | | Weight | Weight | Torque | Final | |
|---|---|---|---|---|---|---|---|---|---|
| | | Tₘᵢₓₜᵤᵣₑ | V | T | (g) of | (g) of | (30 min) | torque | T |
| Ref. | Product | (° C.) | (rpm/min) | (min) | PRC 302 | base | (N · m) | (N · m) | max |
| AP15041 | PRC 302 | 180 | 50 | 10 | 60 | — | 2.75 | 2.6 | 184 |
| AP06051 | PRC 302 + urea | 180 | 100 | 60 | 60 | 1.0 | 4 | 3.5 | 184 |
| AP06052 | PRC 302 + 2A2MP* | 160 | 100 | 60 | 60 | 3.0 | 7.8 | 7 | 166 |
| AP20101 | PRC 302 + zinc | 170 | 50 + 100 | 60 | 60 | 3.0 | 6.3 | 10.7 | 173 |
| | acetate | | | | | | | | |

The torques of the mixture as a function of time are illustrated in FIG. 6. These results clearly illustrate the various bases that enable the reactive monomers of the copolymer to be neutralized.

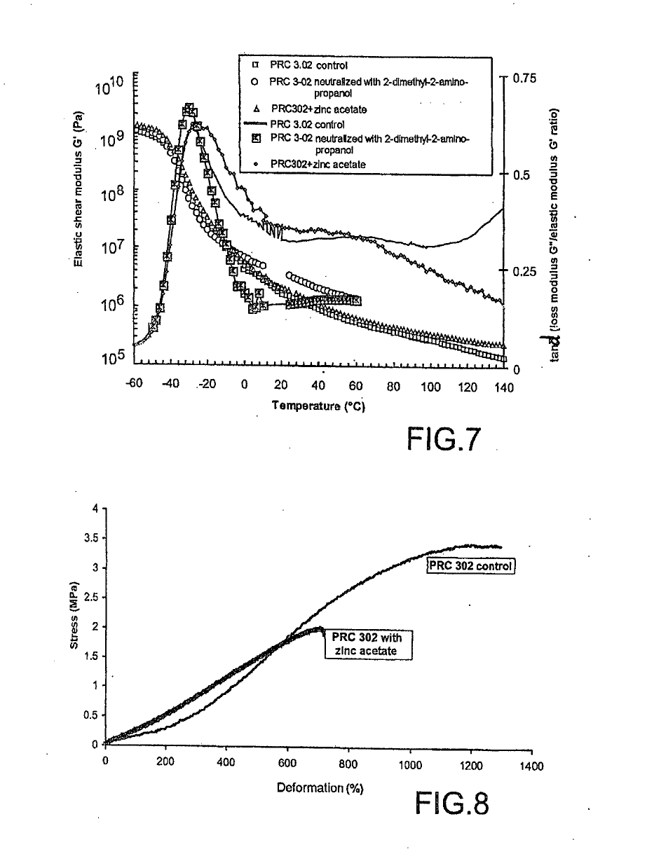

FIG. 7 shows the comparative DMAs of the various products and Table 6 illustrates the modulus increases.

| | | | T_{g} of poly(BuA) |
|---|---|---|---|
| | G′ (25° C.)(Pa) | G′ (60° C.)(Pa) | block |
| PRC 302 | 1.5 × 10⁶ | 5.7 × 10⁵ | −26° C. |
| PRC 302 | 3.5 × 10⁶ | 1.4 × 10⁶ | −30° C. |
| neutralized with | | | |
| 2A2MP | | | |
| Increase factor | 2.3 | 2.5 | |
| PRC 302 | 1.9 × 10⁶ | 6.7 × 10⁵ | −24 |
| neutralized with | | | |
| zinc acetate | | | |
| Increase factor | 1.3 | 1.2 | |

As in the case of KOH, it will be possible to be able to control the modulus level of a given product without affecting the T_{g} of its soft phase and by increasing its temperature resistance. This is also illustrated in FIG. 8.

Table 7 illustrates the following results.

| | | PRC 302 with zinc |
|---|---|---|
| | PRC 302 control | acetate |
| Max stress | 3.2 ± 0.1 | 2.0 ± 0.06 |
| (MPa) | | |
| % deformation | 1200 ± 111 | 724 ± 23 |
| Modulus (Pa) | 143 ± 6 | 245 ± 4 |
| Increase in modulus | | 1.7 |

It shows the assessment of the tensile properties of the product neutralized by zinc acetate: as in the case of the DMA, a slight increase in the modulus of the product is clearly found but smaller than in the case of the potassium hydroxide.

### Example 7

The same principle of being able to adjust the properties of a given copolymer by using ionomers may be applied to all the copolymers claimed in the invention containing reactive groups.

These may be “completely acrylic” copolymers intended for PSA adhesive applications such as PIL 0407 or “completely acrylic” copolymers intended for thermoplastic applications such as DC 59.

Table 8 describes the molten-route mixtures produced with these two copolymers.

| | | | | | Weight | Weight | Torque | Final | T |
|---|---|---|---|---|---|---|---|---|---|
| | | Tₘᵢₓₜᵤᵣₑ | V | T | (g) of | (g) of | (30 min) | torque | max |
| Ref. | Product | (° C.) | (rpm/min) | (min) | polymer | base | (N · m) | (N · m) | (° C.) |
| AP23042 | PIL-0407 + KOH | 180 | 50 then | 60 | 50 | 2.7 | 5.5 | 3.8 | 183 |
| | | | 100 | | | | | | |
| AP26041 | PIL-0407 + KOH | 160 | 50 then | 60 | 50 | 2.7 | 5 | 4.6 | 165 |
| | | | 100 | | | | | | |
| AP27043 | DC59 | 200 | 50 then | 10 | 60 | — | 12* | 12* | 208 |
| | | | 100 | | | | | | |
| AP27041 | DC59 + KOH | 180 | 50 then | 60 | 60 | 2.6 | 25.8 | 25.8 | 205 |
| | | | 100 | | | | | | |
| AP27042 | DC59 + KOH | 200 | 50 then | 10 | 60 | 2.6 | 28* | 28* | 221 |
| | | | 100 | | | | | | |
| 5AP18032 | DC59 + 2A2MP | 160 | 50 then | 60 | 54 | 3.1 | 14.7 | 14.7 | 186 |
| | | | 100 | | | | | | |

*mixed over 10 minutes

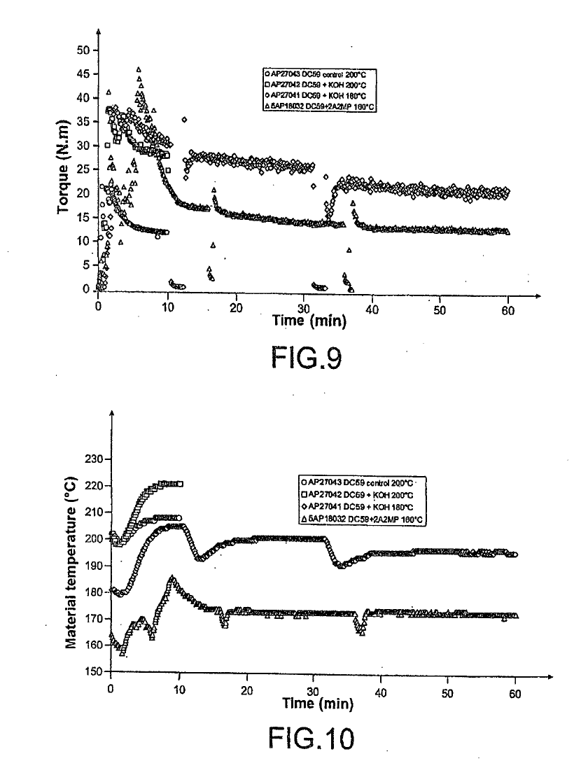

The effect of the neutralization on mixtures with DC 59 is illustrated in FIGS. 9 and 10. FIG. 9 shows the mixing torques as a function of time and FIG. 10 shows the change of the material temperature as a function of time. For the mixtures with the bases, it is possible to see that the temperature rise, with respect to the set temperature, due to the neutralization reaction and to the viscosity increase of the product, is much greater than that of the product without base.

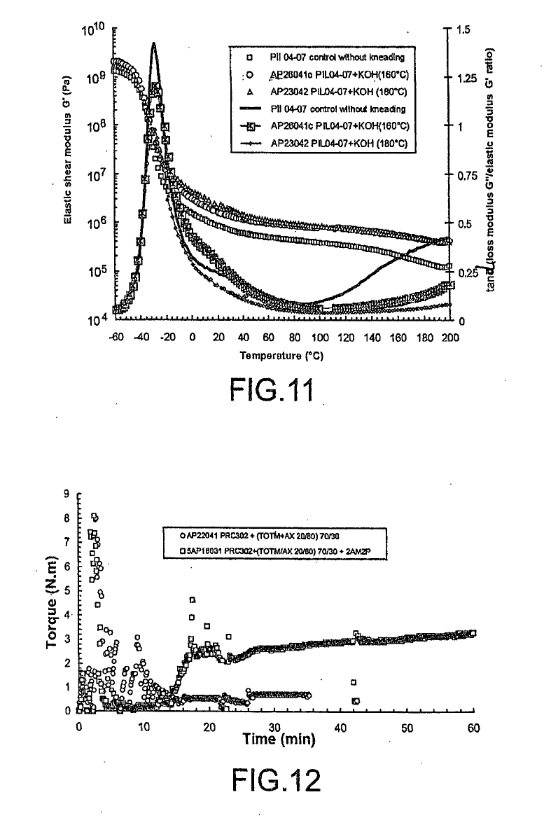

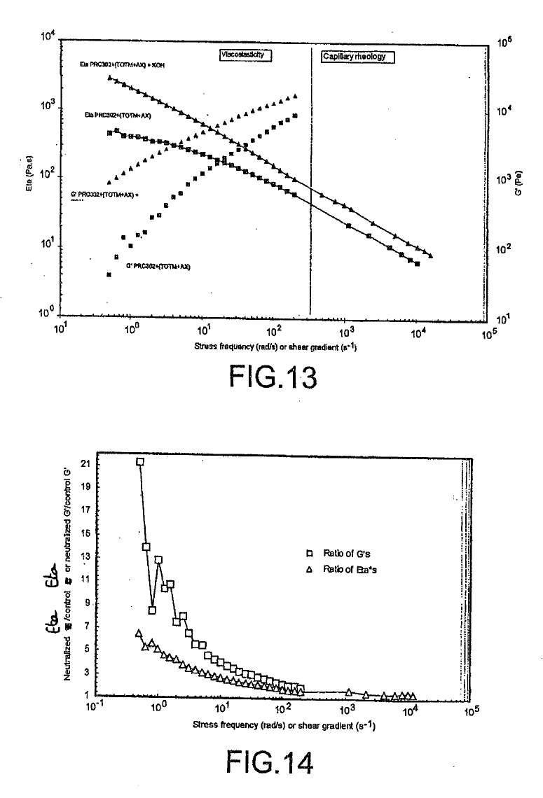

FIG. 11 and Table 9 illustrate for PIL 0407 in comparison with the non-kneaded product, the effect of neutralization on the increase of the mechanical properties of the copolymer.

Table 9 collates the following results:

| | | | T_{g} of poly(BuA) |
|---|---|---|---|
| | G′ (25° C.)(Pa) | G′ (60° C.)(Pa) | block |
| Kneaded MBuA | 7.67 × 10⁵ | 5.7 × 10⁵ | −28° C. |
| PIL-0407 | | | |
| Kneaded MBuA | 1.41 × 10⁶ | 1.2 × 10⁶ | −28° C. |
| PIL-0407 | | | |
| neutralized at | | | |
| 160° C. | | | |
| Kneaded MBuA | 1.88 × 10⁶ | 1.11 × 10⁶ | −28° C. |
| PIL-0407 | | | |
| neutralized at | | | |
| 180° C. | | | |
| Increase at 160° C. | 1.8 | 1.9 | |
| vs initial | | | |
| Increase at 180° C. | 2.5 | 2.2 | |
| vs initial | | | |

The neutralized copolymer has not only a modulus that is twice as high at ambient temperature without having modified the T_{g} of the soft phase, which for a given HMPSA formulation would make it possible to obtain a product with a modulus that was twice as high with respect to the same copolymer formulated without neutralization. But, this copolymer after neutralization also has a clearly better thermal stability as shown by its elastic modulus which varies very little with temperature in comparison to the non-neutralized product. The latter fact is also encountered in the change of tan delta as a function of temperature: after neutralization, PIL 0407 shows a more elastic and less viscous behaviour (lower level of tan δdelta). All these elements must result in HMPSA formulations of which the temperature resistance (or SAFT) will be improved with respect to the non-neutralized product.

In this example, it may also be noted that the neutralization at 180° C. seems more effective than at 160° C. (torque level during mixing in Table 8, modulus level in Table 9, lower tand in graph 11): the neutralization temperature could be used as another parameter in the objective of adapting the thermomechanical properties of a given product.

### Example 8

It has been seen that it was possible, by means of neutralization via a solvent or molten route, to adapt the thermomechanical properties of a copolymer claimed in the invention.

It is also advantageous to be able to produce this neutralization not only at the level of the pure copolymer but also at the level of the copolymer formulation.

By being able to produce the neutralization during the mixing of the various components forming a hot-melt pressure-sensitive adhesive, the formulator will have complete freedom to adapt the properties of the mixture to the application while only having to deal with a single raw material.

To illustrate this concept, it has been chosen to produce an HMPSA formulation from the PRC 302 copolymer used at 70% with 30% of a mixture formed from 20% of a plasticizer, trioctyl trimellitate and 80% of a resin, Foral AX. The properties of a control mixture are compared to those of the same mixture neutralized by 1 equivalent of KOH or by 1 equivalent of 2-amino-2-methylpropanol.

The mixtures were produced in a Brabender mixer at 150° C.: the properties of the three mixtures are given in Table 10.

| | | | | | Weight | Weight | Torque | Final |
|---|---|---|---|---|---|---|---|---|
| | | Tₘᵢₓₜᵤᵣₑ | V | T | (g) of | (g) of | (30 min) | torque |
| Ref. | Product | (° C.) | (rpm/min) | (min) | polymer | base | (N · m) | (N · m) |
| AP22041 | PRC 302 + (TOTM + AX | 150 | 50 then | 60 | 42 | — | 0.7 | 0.7 |
| | 20/80) | | 100 | | 3.6 | | | |
| | 70/30 | | | | 14.4 | | | |
| AP23041 | PRC 302 + (TOTM + AX | 150 | 50 then | 60 | 42 | 1.1 | — | — |
| | 20/80) | | 100 | | 3.6 | | | |
| | 70/30 + KOH | | | | 14.4 | | | |
| 5AP18031 | PRC 302 + (TOTM + AX | 150 | 50 then | 60 | 42 | 1.7 | 2.6 | 3.2 |
| | 20/80) | | 100 | | 3.6 | | | |
| | 70/30 + 2A2MP | | | | 14.4 | | | |

FIG. 12 compares the mixing torques in the Brabender for the control product and the HMPSA neutralized by 2-amino-2-methylpropanol.

The rheological properties of the control formulation and of the product neutralized with potassium hydroxide have been compared in graph 13 using capillary rheology at 160° C. The measurements were carried out using capillary rheology at 160° C. at high shear gradients (eta=f(shear gradient)) and using dynamic viscoelasticity at low shear gradients (eta*=f (stress frequency)) by applying the Cox-Merz principle well known to a person skilled in the art. This example shows that although the viscosity at high shear gradients is slightly affected by the neutralization, the increase in viscosity and elasticity at low shear gradients is much greater as illustrated in FIG. 14 which gives the ratio for each frequency (or shear gradient) of the viscosity or elasticity of the neutralized formulation relative to the control formulation. This constitutes an advantage for all the applications where the creep resistance of the product will be involved.

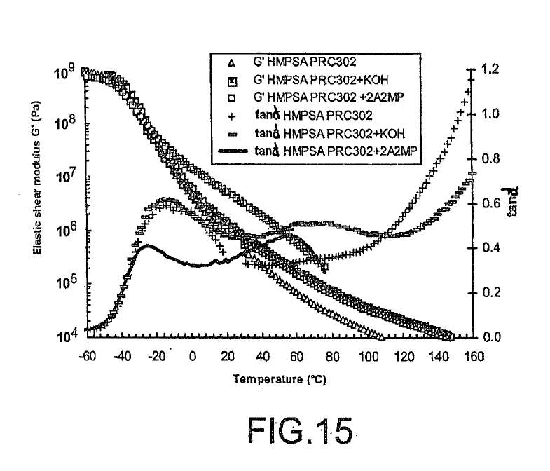

The thermomechanical properties of the control formulation and of the formulation neutralized by 2-amino-2-methylpropanol or KOH were evaluated by DMA. The measurements are given in FIG. 15.

Table 11 illustrates the following results.

| | | | T_{g} |
|---|---|---|---|
| PRC 302 + (TOTM + | | | of poly(BuA) |
| AX 20/80) 70/30 | G′ (25° C.)(Pa) | G′ (60° C.)(Pa) | block |
| Control | 5.50 × 10⁵ | 7.06 × 10⁴ | −14° C. |
| Neutralized with | 9.08 × 10⁵ | 1.76 × 10⁵ | −12° C. |
| KOH | | | |
| Neutralized with | 4.04 × 10⁶ | 6.00 × 10⁵ | −23° C. |
| 2A2MP | | | |
| KOH/control | 1.7 | 2.5 | |
| increase | | | |
| 2A2MP/control | 7.3 | 8.5 | |
| increase | | | |

As shown in Table 11, the neutralization allows an increase of the modulus of the formulation, the magnitude of which may be controlled according to the base used. This increase is appreciable not only at ambient temperature but also at high temperatures, which makes it possible to improve the SAFT properties of a given formulation. This increase is obtained without increasing the T_{g} of the soft phase.

Neutralization therefore makes it possible to reduce the amount of polymer to obtain a formulation with a given modulus, and therefore to reduce the overall cost price of the product. It will however have to have been ensured that the neutralization level of the product is well controlled: thus, in this example, products have been made which are not very tacky and very cohesive with a large part of the polymer whose cohesion has been further strengthened by the neutralization.

1. Linear ethylenic block copolymer comprising:
at least a first block A having a glass transition temperature above 20° C.;
at least a second block B having a glass transition temperature below 15° C.; and
at least a third block C having a glass transition temperature above 20° C.; said first block A and third block C being identical or different and at least one of them comprising at least one monomer unit comprising at least one —CO₂H and/or carboxylate —COO⁻ functional group.

2. Copolymer according to claim 1, in which the monomer unit comprising at least one —CO₂H and/or —COO⁻ functional group is present in an amount ranging from 0.5 to 99 mol %.

3. Copolymer according to claim 2, in which the monomer unit comprising at least one —CO₂H functional group is present in an amount ranging from 3 to 30 mol %.

4. Copolymer according to claim 1, in which the first block A and/or the third block C have a glass transition temperature above 60° C.

5. Copolymer according to claim 1, in which the second block B has a glass transition temperature below −30° C.

6. Copolymer according to claim 1, in which the monomer unit comprising at least one —CO₂H functional group is derived from a monomer corresponding to the formula (I) below: 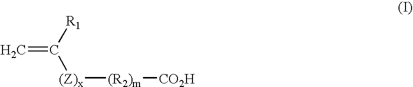
in which:
R₁ is a hydrogen atom or a linear or branched hydrocarbon-based group of CₚH₂ₚ₊₁ type, with p being an integer ranging from 1 to 12;
Z is a divalent group chosen from —COO—, —CONH—, —CONCH₃—, —OCO— or —O—; preferably —COO— and —CONH—;
x is 0 or 1;
R₂ is a saturated or unsaturated, optionally aromatic, linear, branched or cyclic, divalent carbon-based group, comprising from 1 to 30 carbon atoms, which may comprise from 1 to 30 heteroatoms chosen from O, N, S and P; and
m is an integer equal to 0 or 1.

7. Copolymer according to claim 6, in which, in the formula (I), R₁ is a hydrogen atom or a methyl group, x is equal to 0 and m is equal to 0.

8. Copolymer according to claim 6, in which R₂ is:
an alkylene group;
an (ortho, meta or para)-C₆H₄— phenylene group, optionally substituted by a C₁-C₁₂ alkyl group optionally comprising from 1 to 8 heteroatoms chosen from O, N, S and P; or else a —C₆H₄—CH₂— benzylene group optionally substituted by a C₁-C₁₂ alkyl group optionally comprising from 1 to 8 heteroatoms chosen from O, N, S and P; and
a group of formula —CH₂—CHOH—, —CH₂—CH₂—CHOH—, —CH₂—CH₂—CH(NH₂)—, —CH₂—CH(NH₂)—, —CH₂—CH₂—CH(NHR′)—, —CH₂—CH(NHR′)—, —CH₂—CH₂—CH(NR′R″)—, —CH₂—CH(NR′R″)—, —CH₂—CH═CH— with R′ and R″ representing a C₁-C₁₈ linear or branched alkyl group.

9. Copolymer according to claim 1, in which the unit comprising at least one —CO₂H functional group is derived from a monomer chosen from acrylic acid, methacrylic acid, crotonic acid, itaconic acid, fumaric acid, maleic acid, diacrylic acid, dimethylfumaric acid, citraconic acid, vinylbenzoic acid, acrylamidoglycolic acid of formula CH₂═CH—CONHCH(OH)COOH, diallyl maleate of formula C₃H₅—CO₂—CH═CH—CO₂—C₃H₅, butyl (meth)acrylate, carboxylic anhydrides bearing a vinyl bond, and also salts thereof; and mixtures thereof.

10. Copolymer according to claim 1, in which the monomer unit comprising at least one carboxylate —COO⁻ functional group is derived from an amphoteric monomer of formula (II) below: 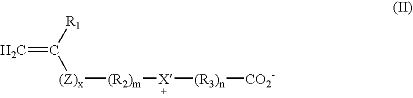
in which:
R₁, Z, x, R₂ and m have the same meanings as in the formula (I) of claim 6;
X′⁺ is a divalent group of formula —N⁺R′₆R′₇ with R′₆ and R′₇ representing, independently of one another,
(i) a hydrogen atom;
(ii) a linear, branched or cyclic, optionally aromatic, alkyl group comprising from 1 to 30 carbon atoms, which may comprise from 1 to 8 heteroatoms chosen from O, N, S and P;
(iii) an alkylene oxide group of formula —(R′₈O)_{y}R′₉ with R′₈ representing a C₂-C₄ linear or branched alkyl group, R′₉ is hydrogen or a C₁-C₃₀, linear or branched, alkyl group and y is an integer ranging from 1 to 250;
(iv) R′₆ and R′₇ may form a saturated or unsaturated, optionally aromatic, ring with the nitrogen atom (NR′₆R′₇ or R′₆NR′₇), comprising in total 5, 6, 7 or 8 atoms, and especially 4, 5, 6 or 7 carbon atoms and/or 2 to 4 heteroatoms chosen from O, S and N; said ring possibly being fused with one or more other saturated or unsaturated, optionally aromatic, rings, each comprising 5, 6, 7 or 8 atoms, and especially 4, 5, 6 or 7 carbon atoms and/or 2 to 4 heteroatoms chosen from O, S and N;
R₃ is a saturated or unsaturated, optionally aromatic, linear, branched or cyclic, divalent carbon-based group having 1 to 30 carbon atoms, which may comprise 1 to 18 heteroatoms chosen from O, N, S and P; and
n is 0 or 1.

11. Copolymer according to claim 10, in which R₃ is:
an alkylene group;
an (ortho, meta or para)-C₆H₄— phenylene group optionally substituted by a C₁-C₁₂ alkyl group optionally comprising from 1 to 5 heteroatoms chosen from O, N, S, F, Si and P; or else a —C₆H₄—CH₂— benzylene group optionally substituted by a C₁-C₁₂ alkyl group optionally comprising from 1 to 5 heteroatoms chosen from O, N, S and P.

12. Copolymer according to claim 1, in which the first block A and/or the third block C comprise(s), moreover, one or more monomer units derived from additional monomers chosen from non-ionic hydrophilic monomers, hydrophobic monomers and mixtures thereof.

13. Copolymer according to claim 12, in which the additional monomer is chosen from, alone or as a mixture:
(i) ethylenic hydrocarbons having 2 to 10 carbons; and
(ii) (meth)acrylates of formula: 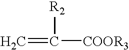
in which R₂ is a hydrogen atom or a methyl (CH₃) group;
and R₃ represents:
a linear or branched alkyl group comprising from 1 to 30 carbon atoms, in which one or more heteroatoms chosen from O, N, S and P are found, optionally inserted; said alkyl group possibly, in addition, being optionally substituted by one or more substituents chosen from OH, halogen atoms (Cl, Br, I and F), and the —Si(R′₄R′₅R′₆) and —Si(R′₄R′₅)O groups, in which R′₄, R′₅ and R′₆, being identical or different, represent a hydrogen atom, a C₁ to C₆ alkyl group or a phenyl group;
a C₃ to C₁₂ cycloalkyl group;
a C₃ to C₂₀ aryl group;
a C₄-C₃₀ aralkyl group (C₁ to C₈ alkyl group);
a heterocyclic group comprising from 4 to 12 ring members containing one or more heteroatoms chosen from O, N, and S, the ring being aromatic or non-aromatic;
a heterocycloalkyl group (alkyl having 1 to 4 carbon atoms); said cycloalkyl, aryl, aralkyl, heterocyclic or heterocycloalkyl groups possibly being optionally substituted by one or more substituents chosen from hydroxyl groups, halogen atoms, and linear or branched C₁-C₄ alkyl groups in which one or more heteroatoms chosen from O, N, S and P are found, optionally inserted, said alkyl groups possibly, in addition, being optionally substituted by one or more substituents chosen from —OH, halogen atoms (Cl, Br, I and F), and the —Si(R′₄R′₅R′₆) and —Si(R′₄R′₅)O groups, in which R′₄, R′₅ and R′₆, being identical or different, represent a hydrogen atom, a C₁ to C₆ alkyl group, or a phenyl group;
an —(OC₂H₄)ₘ—OR″ group, with m=5 to 300 and R″═H or C₁ to C₃₀ alkyl; an —(OC₃H₆)ₘ—OR″ group, with m=5 to 300 and R″═H or C₁ to C₃₀ alkyl; or else a random or block mixture of (OC₂H₄)ₘ and (OC₃H₆)ₘ groups;
(iii) (meth)acrylamides of formula: 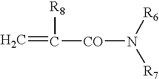
in which R₈ denotes H or methyl;
and R₇ and R₆, being identical or different, represent:
a hydrogen atom; or
a linear or branched alkyl group having 1 to 30 carbon atoms, in which one or more heteroatoms chosen from O, N, S and P are found, optionally inserted; said alkyl group possibly, in addition, being optionally substituted by one or more substituents chosen from —OH, halogen atoms (Cl, Br, I and F), and the —Si(R′₄R′₅R′₆) and —Si(R′₄R′₅)O groups, in which R′₄, R′₅ and R′₆ represent a hydrogen atom, a C₁ to C₆ alkyl group or a phenyl group;
a C₃ to C₁₂ cycloalkyl group;
a C₃ to C₂₀ aryl group;
a C₄ to C₃₀ aralkyl group (C₁ to C₈ alkyl group);
a heterocyclic group comprising from 4 to 12 ring members containing one or more heteroatoms chosen from O, N, and S, the ring being aromatic or non-aromatic;
a heterocycloalkyl group (C₁-C₄ alkyl);
said cycloalkyl, aryl, aralkyl, heterocyclic or heterocycloalkyl groups possibly being optionally substituted by one or more substituents chosen from hydroxyl groups, halogen atoms, and linear or branched C₁-C₄ alkyl groups in which one or more heteroatoms chosen from O, N, S and P are found, optionally inserted, said alkyl groups possibly, in addition, being optionally substituted by one or more substituents chosen from —OH, halogen atoms (Cl, Br, I and F), and the —Si(R′₄R′₅R′₆) and —Si(R′₄R′₅)O groups, in which R′₄, R′₅ and R′₆, being identical or different, represent a hydrogen atom, a C₁ to C₆ alkyl group, or a phenyl group;
an —(OC₂H₄)ₘ—OR″ group, with m=5 to 300 and R″═H or C₁ to C₃₀ alkyl; an —(OC₃H₆)ₘ—OR″ group, with m=5 to 300 and R″═H or C₁ to C₃₀ alkyl; or else a random or block mixture of (OC₂H₄)ₘ and (OC₃H₆)ₘ groups;
(iv) vinyl compounds of formula:
CH₂═CH—R₉
in which R₉ is a hydroxyl group; a halogen (Cl or F); an NH₂ group; an —OR₁₀ group where R₁₀ represents a phenyl group or a C₁ to C₁₂ alkyl group (the monomer is a vinyl or allyl ether); an acetamide (NHCOCH₃) group; an OCOR₁₁ group where R₁₁ represents a linear or branched alkyl group having 2 to 12 carbons (the monomer is a vinyl or allyl ester), a C₃-C₁₂ cycloalkyl group, a C₃-C₂₀ aryl group or a C₄-C₃₀ arallyl group; or else R₉ is chosen from:
a linear or branched alkyl group comprising 1 to 30 carbon atoms, in which one or more heteroatoms chosen from O, N, S and P are found, optionally inserted; said alkyl group possibly, in addition, being optionally substituted by one or more substituents chosen from —OH, halogen atoms (Cl, Br, I and F), and the —Si(R′₄R′₅R′₆) and —Si(R′₄R′₅)O groups, in which R′₄, R′₅ and R′₆, being identical or different, represent a hydrogen atom, a C₁ to C₆ alkyl group or a phenyl group;
a C₃ to C₁₂ cycloalkyl group;
a C₃ to C₂₀ aryl group;
a C₄ to C₃₀ arylalkyl or alkylaryl group (C₁ to C₈ alkyl group);
a heterocyclic group having 4 to 12 ring members containing one or more heteroatoms chosen from O, N, and S, the ring being aromatic or non-aromatic;
a heterocycloalkyl group (alkyl having 1 to 4 carbon atoms); said cycloalkyl, aryl, aralkyl, heterocyclic or heterocycloalkyl groups possibly being optionally substituted by one or more substituents chosen from hydroxyl groups, halogen atoms, and linear or branched alkyl groups having 1 to 4 carbon atoms in which one or more heteroatoms chosen from O, N, S and P are found, optionally inserted, said alkyl groups possibly, in addition, being optionally substituted by one or more substituents chosen from —OH, halogen atoms (Cl, Br, I and F), and the —Si(R′₄R′₅R′₆) and —Si(R′₄R′₅)O groups, in which R′₄, R′₅ and R′₆, being identical or different, represent a hydrogen atom, a C₁ to C₆ alkyl group, or a phenyl group;
(v) the allyl compounds of formula:
CH₂═CH—CH₂—R₉ or CH₂═C(CH₃)—CH₂—R₉
in which R₉ has the same meaning as above; and
(vi) (meth)acrylic, (meth)acrylamide or silicone-containing vinyl monomers.

14. Copolymer according to claim 12, in which the additional monomer is chosen from, alone or as a mixture:
hydroxyalkyl (meth)acrylates and (meth)acrylamides of which the alkyl group comprises 2 to 4 carbon atoms;
(C₁-C₄)alkoxy (C₁-C₄)alkyl (meth)acrylates and (meth)acrylamides;
(meth)acrylamide and N,N-dimethylacrylamide;
(meth)acrylates and (meth)acrylamides having an —(OC₂H₄)ₘ—OR″ group, with m=5 to 300 and R″═H or C₁ to C₄ alkyl;
vinyl lactams;
vinyl ethers;
vinylacetamide, N-vinylpyrrolidone or N-vinylcaprolactam; and
polysaccharide (meth)acrylates such as saccharose acrylate and ethyl glucoside (meth)acrylate.

15. Copolymer according to claim 12, in which the additional monomer is chosen from, alone or as a mixture:
t-butylbenzyl acrylate, t-butylcyclohexyl acrylate, isobornyl acrylate (94° C.), furfuryl acrylate, n-hexyl acrylate (45° C.), t-butyl acrylate (50° C.), cyclohexyl acrylate (19° C.), hydroxyethyl acrylate (15° C.), methyl acrylate (10° C.), ethyl acrylate (−24° C.), isobutyl acrylate (−24° C.), methoxyethyl acrylate (−33° C.), n-butyl acrylate (−54° C.), ethylhexyl acrylate (−50° C.), hexyl acrylate, octyl acrylate, lauryl acrylate, isooctyl acrylate, isodecyl acrylate;
t-butylbenzyl methacrylate, t-butylcyclohexyl methacrylate, isobornyl methacrylate (111° C.), methyl methacrylate (100° C.), cyclohexyl methacrylate (83° C.), ethyl methacrylate (65° C.), benzyl methacrylate (54° C.), isobutyl methacrylate (53° C.), butyl methacrylate (20° C.), n-hexyl methacrylate (−5° C.), ethylhexyl methacrylate, octyl methacrylate, lauryl methacrylate, isooctyl methacrylate, isodecyl methacrylate;
styrene (100° C.), vinylcyclohexane, vinylacetate (23° C.), vinyl methyl ether (−34° C.), vinyl neononanoate, vinyl neododecanoate;
N-butylacrylamide, N-isopropylacrylamide, N,N-dimethylacrylamide, N,N-dibutylacrylamide, N-t-butylacrylamide, N-octylacrylamide.

16. Copolymer according to claim 1, in which the block B comprises monomer units derived from non-ionic hydrophilic and/or hydrophobic monomers as defined above.

17. Copolymer according to claim 1, which is a triblock copolymer of A-B-C type.

18. Copolymer according to claim 17, in which the block B is present in an amount ranging from 5 to 95% by weight of the copolymer.

19. Copolymer according to claim 17, in which the block B is present in an amount greater than 50% by weight of the copolymer.

20. Copolymer according to claim 17, in which the block A and/or C comprises:
monomer units derived from non-ionic monomers chosen from:
vinyl compounds of formula CH₂═CH—R₉, R₉;
methacrylate compounds of formula: 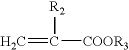
with R₂ and R₃ being as defined in claim 13; and
mixtures of these; and
monomer units bearing at least one —CO₂H functional group derived from monomers chosen from acrylic acid or methacrylic acid.

21. Copolymer according to claim 20, in which the monomer units derived from non-ionic monomers are present in an amount ranging from 1 to 99.5% relative to the total weight of the block.

22. Copolymer according to claim 20, in which the monomer units bearing at least one —CO₂H functional group are present in an amount ranging from 0.5 to 99% relative to the total weight of the block.

23. Copolymer according to claim 20, in which the block B comprises monomer units derived from monomers chosen from (meth)acrylates of formula: 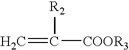
with R₂ and R₃ being as defined in claim 13.

24. Copolymer according to claim 23, in which the (meth)acrylate monomers are chosen from n-hexyl methacrylate (T_{g}=−5° C.), ethyl acrylate (T_{g}=−24° C.), isobutyl acrylate (T_{g}=−24° C.), n-butyl acrylate (T_{g}=−54° C.), ethylhexyl acrylate (T_{g}=−50° C.).

25. Copolymer according to claim 17, in which the triblock copolymer is chosen from poly(styrene-co-methacrylic acid)-b-poly(n-butyl acrylate)-b-poly(styrene-co-methacrylic acid), poly(methyl methacrylate-co-methacrylic acid)-b-poly(n-butyl acrylate)-b-poly(methyl methacrylate-co-methacrylic acid).

26. Copolymer according to claim 25, in which the poly(styrene-co-methacrylic acid)-b-poly(n-butyl acrylate)-b-poly(styrene-co-methacrylic acid) copolymer is that for which:
the poly(n-butyl acrylate) block represents 71% by weight of the total copolymer;
the poly(styrene-co-methacrylic acid) blocks each comprise monomer units derived from methacrylic acid in an amount of 2% by weight of the total copolymer and monomer units derived from styrene in an amount of 12.5% by weight of the total copolymer; and
a weight-average molecular weight of 372 000 g/mol.

27. Copolymer according to claim 25, in which the poly(methyl methacrylate-co-methacrylic acid)-b-poly(n-butyl acrylate)-b-poly(methyl methacrylate-co-methacrylic acid) copolymer is that for which:
the poly(n-butyl acrylate) block represents 35% by weight of the total copolymer;
the poly(methyl methacrylate-co-methacrylic acid) blocks each comprise monomer units derived from methacrylic acid in an amount of 3.25% by weight of the total copolymer and monomer units derived from methyl methacrylate in an amount of 29.25% by weight of the total copolymer; and
a weight-average molecular weight of 150 000 g/mol.

28. Copolymer according to claim 25, in which the poly(methyl methacrylate-co-methacrylic acid)-b-poly(n-butyl acrylate)-b-poly(methyl methacrylate-co-methacrylic acid) copolymer is that for which:
the poly(n-butyl acrylate) block represents 65% by weight of the total copolymer;
the poly(methyl methacrylate-co-methacrylic acid) blocks each comprise monomer units derived from methacrylic acid in an amount of 1.6% by weight of the total copolymer and monomer units derived from methyl methacrylate in an amount of 15.9% by weight of the total copolymer; and
a weight-average molecular weight of 95 000 g/mol.

29. Composition comprising at least 1%—by weight, relative to the total weight of the composition, of a copolymer as defined according to any one of claim 1.

30. Composition according to claim 29, in which the copolymer is neutralized, completely or partly, by a mineral or organic base.

31. Composition according to claim 30, in which the mineral base is chosen from alkali metal hydroxides, alkaline-earth metal hydroxides, metal hydroxides and metalloid hydroxides.

32. Composition according to claim 31, in which the organic base is an amine.

33. Composition according to claim 31, in which the amine is an amine having a boiling point above 200° C. at 1 atm.

34. Composition according to claim 30, in which the degree of neutralization is greater than 0.1, preferably greater than 0.5.

35. Composition according to claim 29, which is an adhesive composition.

36. Composition according to claim 35, in which the copolymer is present in an amount of at least 5% by weight relative to the total weight of the composition.

37. Composition according to claim 35, comprising, in addition, an additive chosen from tackifying resins and plasticizers.

38. Composition according to claim 37, in which the plasticizer is chosen from trimellitate type oils and predominantly naphthenic oils.

39. Composition according to claim 37, in which the tackifying resin is chosen from resins based on rosin(s), rosin ester, polyterpene, hydroxylated polyester, terpene-styrene, terpene-pentaerythritol or terpene-phenol.

40. Adhesive strips, labels and tapes comprising a composition as defined according to claim 35.

41. Composition according to claim 29, which is a thermoplastic composition.

42. Composition according to claim 41, comprising, in addition, one or more thermoplastic polymers.

43. Composition according to claim 42, in which the thermoplastic polymer is chosen from polymethyl methacrylate, polystyrene and polyvinyl chloride.

44. Process for preparing a composition as defined in claim 30, comprising a step of bringing the copolymer into contact, in a liquid medium, with a mineral or organic base.

45. Process for preparing a composition as defined in claim 30, comprising a step of bringing the copolymer into contact, via a molten route, with a mineral or organic base.

46. Use of a copolymer as defined according to claim 1, as a hot-melt adhesive.

47. A method comprising providing a hot melt adhesive with a copolymer of claim 1 and applying said hot melt adhesive to a substrate.
